(19) United States
(12) Patent Application Publication
(10) Pub. No.: US 2008/0080390 A1
(43) Pub. Date: Apr. 3, 2008

(54) PACKET LOSS RATE CALCULATION SYSTEM

(75) Inventors: Ryuichi Ebuchi, Fukuoka (JP); Fumiharu Etoh, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/845,891

(22) Filed: Aug. 28, 2007

(30) Foreign Application Priority Data
Sep. 28, 2006 (JP) 2006-265890

(51) Int. Cl. H04L 12/56

(52) U.S. Cl. 370/253

(57) ABSTRACT

A sending probe sends a quality measurement packet to a receiving probe, and increments a sent packet counter every time the quality measurement packet is sent. A receiving probe receives the quality measurement packet from the sending probe, and attaches a received packet counter to the quality measurement packet and returns the quality measurement packet to the sending probe. The sending probe receives a returned quality measurement packet, extracts a received packet count from the quality measurement packet, and calculates a packet loss rate by using a difference between the sent packet counter and the received packet counter and a difference between the received packet counter and the returned packed counter.

### BACKGROUND OF THE INVENTION

1. Field of the Invention

The present invention relates to a technology for calculating a packet loss rate between measuring points based on information obtained from packets for quality measurement.

2. Description of the Related Art

There is a conventional method of active measurement of service quality in which packets for quality measurement are actively sent to simulate arbitrary service for the purpose of measurement of a service quality (for example, a packet loss rate). To implement such a measurement of service quality, a sending probe and a receiving probe as measuring device (such as probe or server) for arbitrary quality measurement are located at arbitrary measuring points in the network. The sending probe generates and sends actively packets for quality measurement between the sending probe and the receiving probe, one or multiple receiving probes receive these packets and returned them to the sending probe, and quality measurement value is calculated by using the arbitrary information of the measurement obtained from the sent and returned packets for quality measurement.

For example, in Japanese Patent Application Laid-open No. 2005-269170, a method is disclosed in which, as a technique to calculate packet loss rate by using the time information obtained from quality measurement packets, the receiving time information of quality measurement packets at the receiving probe and the sending time information of the quality measurement packets from the receiving probe are obtained, and the packet loss rate is calculated by using the obtained receiving time and sending time information.

According to another conventional technology, as a method to calculate packet loss rate by using sent and received packet counts obtained from quality measurement packets, a method is used in which a packet count of quality measurement packets sent from the sending probe to the receiving probe (hereinafter, “S”) and a packet count of quality measurement packets sent from the receiving probe to the sending probe (hereinafter, “R”) are obtained, then the packet loss rate is calculated by using the obtained S and R. In particular, the packet loss rate is calculated by using an equation (R−S)/S.

These conventional methods have problems that it is unable to calculate packet loss rate with high accuracy or it is unable to calculate packet loss rate in forward and return path individually.

Namely, according to the technology disclosed in Japanese Patent Application Laid-open No. 2005-269170, there is a problem that it is unable to calculate packet loss rate with high accuracy because the packet loss rate is calculated by using time information and therefore there is not necessarily cause-and-effect relationship between the time information and the packet loss rate.

Furthermore, according to the conventional technology described above, there is another problem that it is unable to calculate the packet loss rate in a forward path from the sending probe to the receiving probe or a backward path from the receiving probe to the sending probe, because the packet loss rate is calculated only through a round trip path between the sending probe and the receiving probe.

### SUMMARY OF THE INVENTION

It is an object of the present invention to at least partially solve the problems in the conventional technology.

A packet loss rate calculation system according to one aspect of the present invention exchanges a quality measurement packet for measuring quality of service between a sending probe and a receiving probe and calculates a packet loss rate between measuring points based on information obtained from the quality measurement packet. The sending probe includes a sent packet count memory unit that stores a sent packet count of quality measurement packets sent to the receiving probe, a returned packet count memory unit that stores a returned packet count of quality measurement packets returned from the receiving probe, a measurement packet sending unit that sends the quality measurement packet to the receiving probe, a packet count incrementing unit that increments the sent packet count stored in the sent packet count memory unit every time the measurement packet sending unit sends the quality measurement packet, a measurement packet extracting unit that receives the returned quality measurement packet, and extracts a received packet count indicating a packet count received by the receiving probe from the quality measurement packets, a returned packet count incrementing unit that increments the returned packet count stored in the returned packet count memory unit every time the returned quality measurement packet is received, and a loss rate calculation unit that calculates the packet loss rate by using a difference between the sent packet count stored in the sent packet count memory unit and the received packet count extracted by the measurement packet extracting unit and a difference between the received packet count extracted by the measurement packet extracting unit and the returned packet count stored in the returned packet count memory unit. The receiving probe includes a received packet count memory unit that stores a received packet count of quality measurement packets received from the sending probe, a measurement packet receiving unit that receives the quality measurement packet sent by the measurement packet sending unit, a received packet count incrementing unit that increments the received packet count stored in the received packet count memory unit every time the measurement packet receiving unit receives the quality measurement packet, and a measurement packet returning unit that attaches the received packet count stored in the received packet count memory unit to the quality measurement packet, and returns the quality measurement packet with the received packet count attached to the sending probe every time the measurement packet receiving unit receives the quality measurement packet.

A computer-readable recording medium according to another aspect of the present invention stores therein a computer program for exchanging a quality measurement packet for measuring quality of service between a sending probe and a receiving probe and calculating a packet loss rate between measuring points based on information obtained from the quality measurement packet. The computer program causes a computer to execute as the sending probe sent packet count storing including storing a sent packet count of quality measurement packets sent to the receiving probe, returned packet count storing including storing a returned packet count of quality measurement packets returned from the receiving probe, measurement packet sending including sending the quality measurement packet to the receiving probe, packet count incrementing including incrementing the sent packet count stored at the sent packet count storing every time the quality measurement packet is sent, measurement packet extracting including receiving the returned quality measurement packet, and extracting a received packet count indicating a packet count received by the receiving probe from the quality measurement packets, returned packet count incrementing including incrementing the returned packet count stored at the returned packet count storing every time the returned quality measurement packet is received, and loss rate calculating including calculating the packet loss rate by using a difference between the sent packet count stored at the sent packet count storing and the received packet count extracted at the measurement packet extracting and a difference between the received packet count extracted at the measurement packet extracting and the returned packet count stored at the returned packet count storing. The computer program causes a computer to execute as the receiving probe received packet count storing including storing a received packet count of quality measurement packets received from the sending probe, measurement packet receiving including receiving the quality measurement packet sent at the measurement packet sending, received packet count incrementing including incrementing the received packet count stored at the received packet count storing every time the quality measurement packet is received, and measurement packet returning including attaching the received packet count stored at the received packet count storing to the quality measurement packet, and returning the quality measurement packet with the received packet count attached to the sending probe every time the quality measurement packet is received.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an outline and features of a packet loss rate calculation system according to a first embodiment of the present invention;

FIG. 2 is a diagram of a total structure of a packet loss rate calculation system according to the first embodiment;

FIG. 3 is a block diagram of a structure of a sending probe according to the first embodiment;

FIG. 4 is diagram for explaining a sent packet counter memory unit;

FIG. 5 is a diagram for explaining a received packet maximum value counter memory unit;

FIG. 6 is a diagram for explaining a returned packet counter memory unit;

FIG. 7 is a diagram for explaining REGISTER;

FIG. 8 is a diagram for explaining establishment of a session by SIP;

FIG. 9 is a diagram for explaining termination of a session by SIP;

FIG. 10 is a diagram for explaining a structure of a quality measurement packet in the forward path;

FIG. 11 is a block diagram of a structure of a receiving probe according to the first embodiment;

FIG. 12 is a diagram for explaining a received packet counter memory unit;

FIG. 13 is a diagram for explaining a structure of a quality measurement packet in the backward path;

FIG. 14 is a flowchart of a sending process procedure of a sending probe according to the first embodiment;

FIG. 15 is a flowchart of a return process procedure of a receiving probe according to the first embodiment;

FIG. 16 is a flowchart of a calculation process procedure of a sending probe according to the first embodiment;

FIG. 17 is a diagram for explaining an outline and features of a packet loss rate calculation system according to a second embodiment of the present invention;

FIG. 18 is a block diagram of a structure of a sending probe according to the second embodiment;

FIG. 19 is a diagram for explaining a structure of a measurement confirmation packet in the forward path;

FIG. 20 is a block diagram of a structure of a receiving probe according to the second embodiment;

FIG. 21 is a diagram for explaining a structure of a measurement confirmation packet in the backward path;

FIG. 22 is a flowchart of a sending process procedure of a sending probe according to the second embodiment;

FIG. 23 is flowchart of a returning process procedure of a receiving probe according to the second embodiment;

FIG. 24 is a flowchart of a calculating process procedure of a sending probe according to the second embodiment;

FIG. 25 is a diagram for explaining an outline and features of a packet loss rate calculation system according to a third embodiment of the present invention;

FIG. 26 is a block diagram of a structure of a sending probe according to the third embodiment;

FIG. 27 is a block diagram of a structure of a receiving probe according to the third embodiment;

FIG. 28 is a flowchart of a sending process procedure of a sending probe according to the third embodiment;

FIG. 29 is a flowchart of a returning process procedure of a receiving probe according to the third embodiment;

FIG. 30 is a flowchart of a calculating process procedure of a sending probe according to the third embodiment; and

FIG. 31 is a diagram of a computer that performs packet loss rate calculation process procedures.

### DETAILED DESCRIPTION OF THE PREFERRED EMBODIMENTS

Exemplary embodiments of the present invention are explained in detail below with reference to the accompanying drawings.

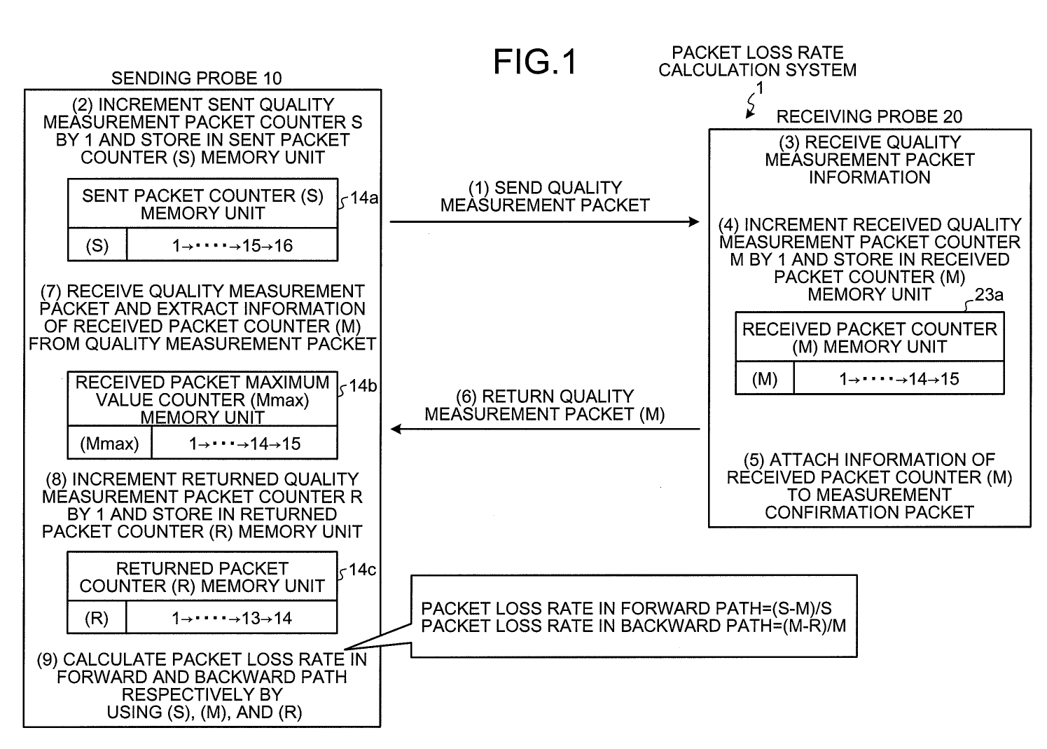

FIG. 1 is a diagram for explaining an outline and features of a packet loss rate calculation system 1 according to a first embodiment of the present invention.

In the packet loss rate calculation system 1 according to the first embodiment, quality measurement packets for quality measurement are sent and received between a sending probe 10 and a receiving probe 20 which are located at arbitrary measuring points, and a packet loss rate between the measuring points is calculated by using information obtained from the quality measurement packets. The packet loss rate calculation system 1 features in calculation of packet loss rate with high accuracy in a forward path as well as in a backward path.

Explaining the main feature specifically, the sending probe 10 includes, as shown in FIG. 1, a sent packet counter memory unit 14a to store a packet count of quality measurement packets sent to the receiving probe 20, a received packet maximum value counter memory unit 14b to store the maximum value of packet count of quality measurement packets received from the sending probe 10, and a returned packet counter memory unit 14c to store packet count of quality measurement packets returned from the receiving probe 20. The receiving probe 20 includes a received packet counter memory unit 23a to store packet count of quality measurement packets received from the sending probe 10.

In this structure, on receiving a scenario, for example a measurement start time, for voice quality measurement from a voice quality measurement server 60, the sending probe 10 of the packet loss rate calculation system 1 waits the measurement start time in the scenario, and sends quality measurement packets to the receiving probe 20 at that time point (see (1) in FIG. 1). The sending probe 10 increments a sent packet counter (S) stored in the sent packet counter memory unit 14a every time a quality measurement packet is sent (see (2) in FIG. 1).

Then, the receiving probe 20 receives quality measurement packets sent by the sending probe 10 (see (3) in FIG. 1), increments a received packet counter (M) stored in the received packet counter memory unit 23a every time a quality measurement packet is received (see (4) in FIG. 1). Every time a quality measurement packet is received, the receiving probe 20 attaches (see (5) in FIG. 1) the received packet counter (M) stored in the received packet counter memory unit 23a to the quality measurement packet and returns this to the sending probe 10 (see (6) in FIG. 1).

The sending probe 10 receives the quality measurement packets returned from the receiving probe 20, then extracts, from the quality measurement packets, a received packet count that indicates the packet count received by the receiving probe 20, stores it in the received packet maximum value counter memory unit 14b as the maximum value of received packet count of the quality measurement packets (see (7) in FIG. 1). Every time a quality measurement packet returned from the receiving probe 20 is received, the sending probe 10 increments a returned packet counter (R) that is stored in the returned packet counter memory unit 14c(see (8) in FIG. 1).

After receiving all quality measurement packets, the sending probe 10 calculates packet loss rate by using the difference between the sent packet counter (S) that is stored in the sent packet counter memory unit 14a and the extracted received packet counter (M), and the difference between the extracted received packet counter (M) and the returned packet counter (R) stored in the returned packet counter memory unit 14c (see (9) in FIG. 1). In particular, when time-out of a timer, which will be described in detail later, occurs, the sending probe 10 stops receiving quality measurement packets and then calculates the packet loss rate in the forward path by dividing the difference between the sent packet counter (S) and the received packet counter (M) by the sent packet counter (S), ((S−M)/S). The sending probe 10 also calculates the packet loss rate in the backward path by dividing the difference between the received packet counter (M) and the returned packet counter (R) by the received packet counter (M), ((M−R)/M).

Thus, the packet loss rate calculation system 1 has a main feature in calculation of packet loss rate with high accuracy in a forward path and a backward path because it calculates the packet loss rate in the forward path and the packet loss rate in the backward path individually by using the sent packet counter, the received packet counter, and the returned packet counter.

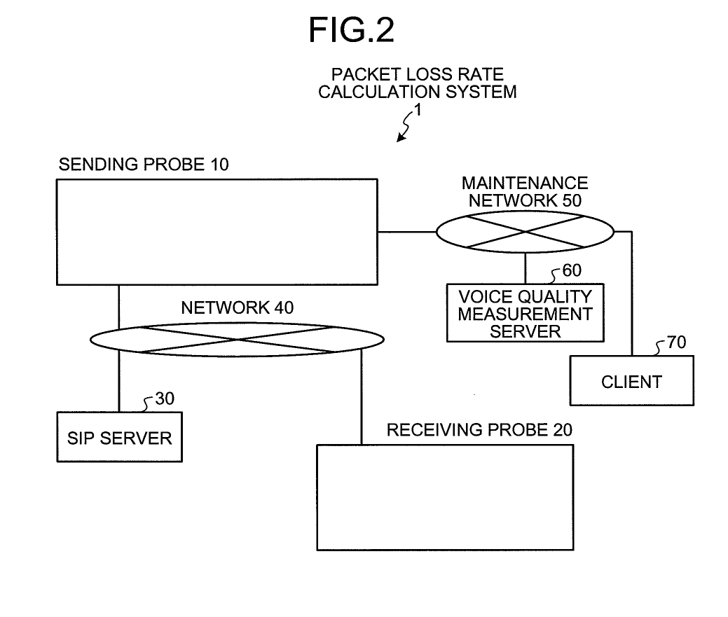

FIG. 2 is a diagram of the total structure of the packet loss rate calculation system 1 according to the first embodiment. As shown in the FIG. 2, the packet loss rate calculation system 1 includes the sending probe 10, the receiving probe 20, a SIP server 30, the voice quality measurement server 60, and a client 70. The sending probe 10, the receiving probe 20, and the SIP server 30 are connected via a network 40. The sending probe 10, the voice quality measurement server 60, and the client 70 are connected via a maintenance network 50. A method of measuring voice quality by using VoIP that utilizes a SIP protocol as signal to establish voice connection and a RTP protocol to send voice packets on the voice connection in the packet loss rate calculation system 1 is described below.

The SIP server 30 is a server that supports processes such as establishment of a session needed for SIP telephone call on the network 40. The voice quality measurement server 60 is a device to control voice quality measurement activity of the sending probe 10 and the receiving probe 20, to collect and store measurement result by the probes, and distributes a scenario for voice quality measurement to the sending probe 10. The voice quality measurement server 60 receives packet loss rate in the forward path as well as packet loss rate in the backward path from the sending probe 10, and sends packet loss rate to the client 70 in response to request from the client 70. The client 70 is a device that is used by a user to control the voice quality measurement server 60, and sends request to the voice quality measurement server 60 for sending packet loss rate, receives information about packet loss rate from the voice quality measurement server 60 and outputs it.

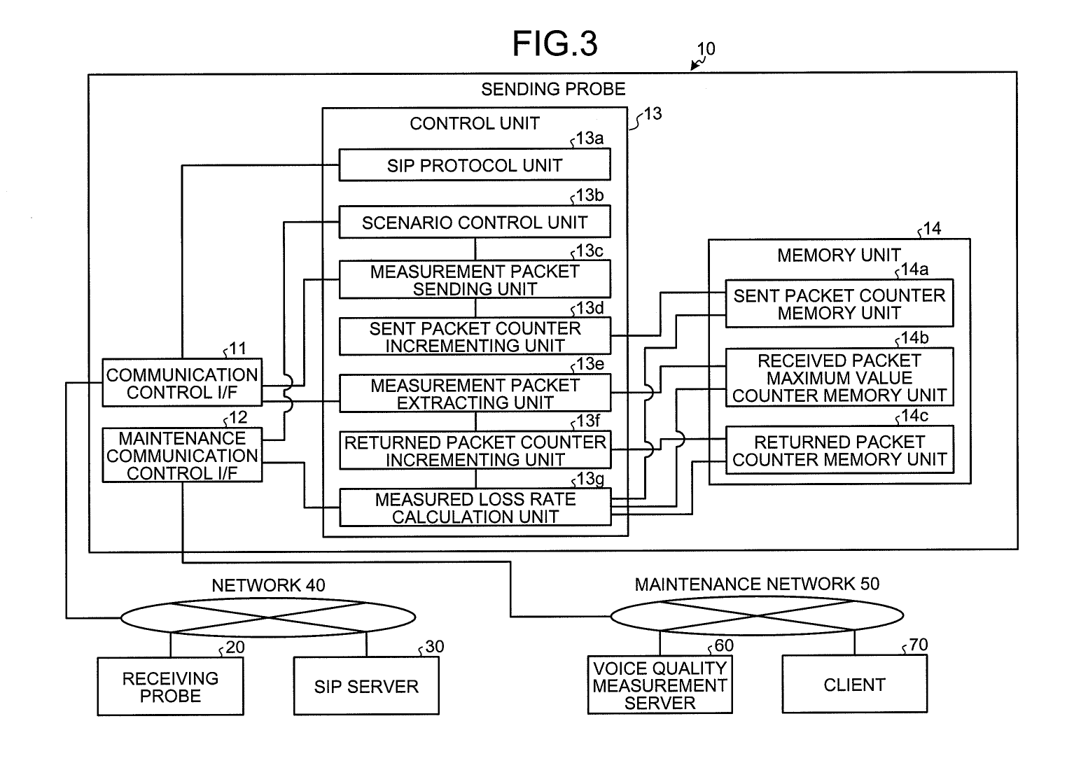

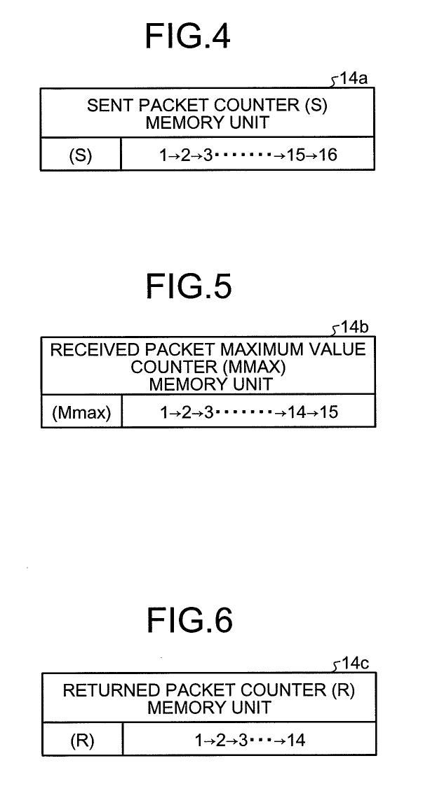

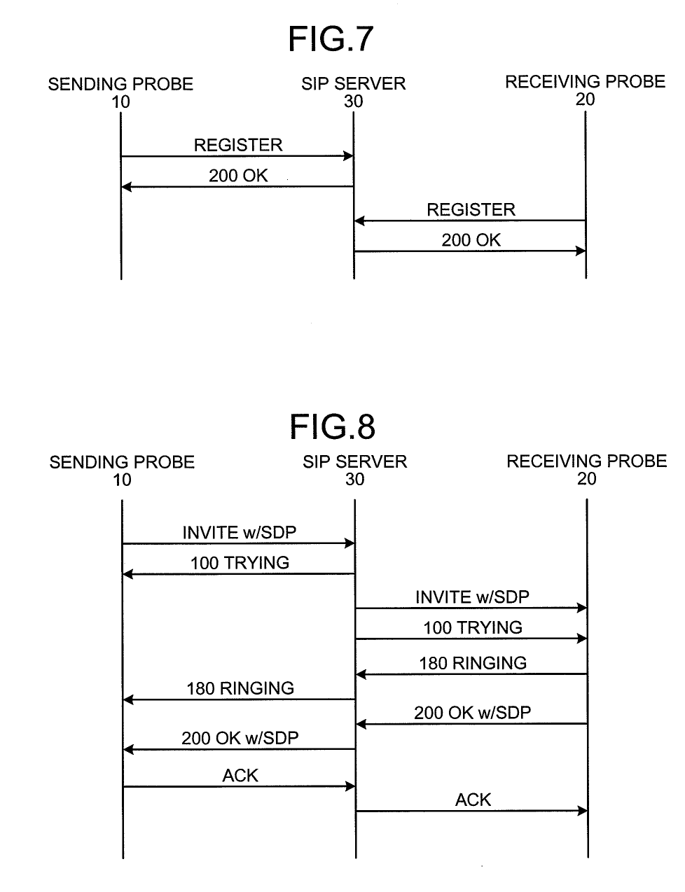

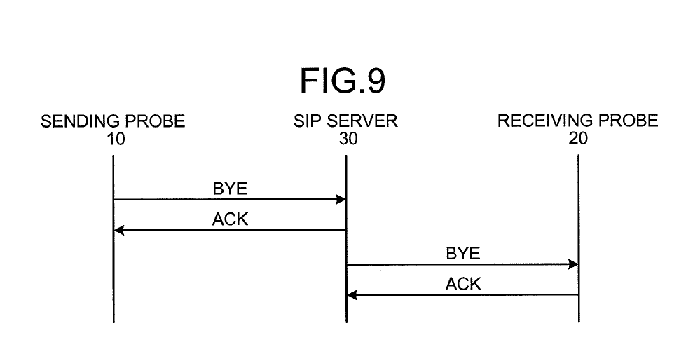

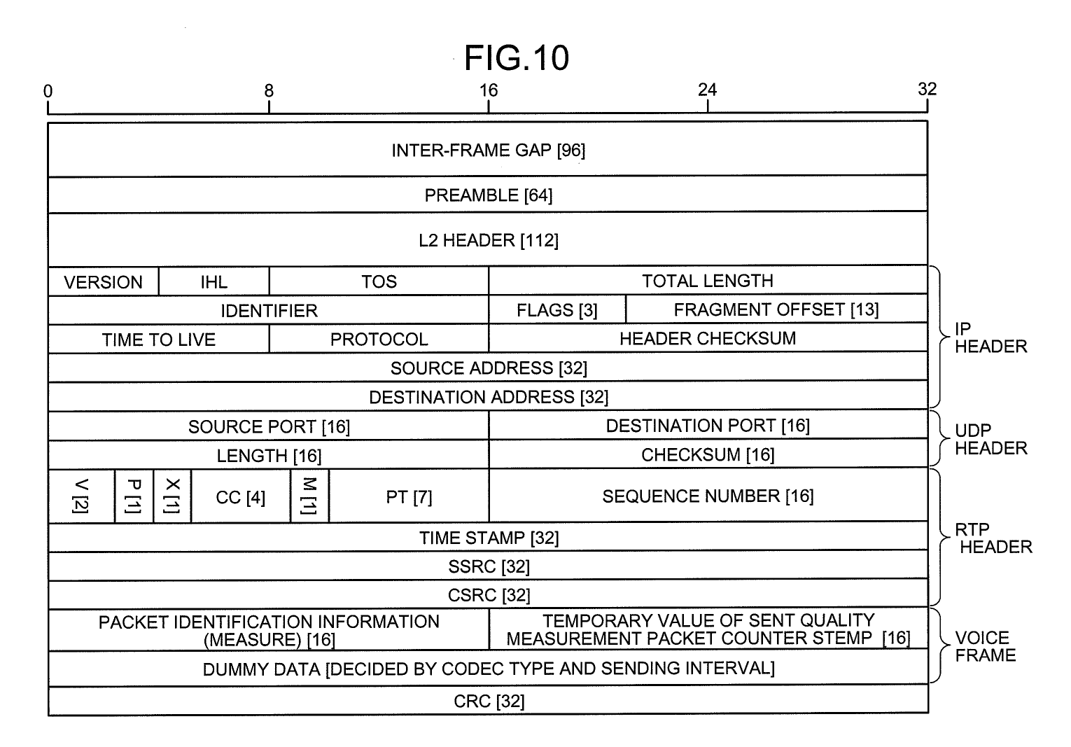

FIG. 3 is a block diagram of the structure of the sending probe 10 according to the first embodiment. FIG. 4 is a diagram for explaining of the sent packet counter memory unit 14a. FIG. 5 is a diagram for explaining of the received packet maximum value counter memory unit. FIG. 6 is a diagram for explaining of the returned packet counter memory unit. FIG. 7 is a diagram for explaining of a register. FIG. 8 is a diagram for explaining of establishment of a session by the SIP. FIG. 9 is a diagram for explaining of close of a session by the SIP. FIG. 10 is a diagram for explaining of the structure of a quality measurement packet in the forward path.

As shown in FIG. 3, the sending probe 10 includes a communication control I/F 11, a maintenance communication control I/F 12, a control unit 13, and a memory unit 14, and is connected to the receiving probe 20 and the SIP server 30 via the network 40, and is connected to the voice quality measurement server 60 and the client 70 via the maintenance network 50. Processes in each unit are described below.

The communication control I/F 11 controls communication regarding various information between it and the receiving probe 20 as well as the SIP server 30 which are connected to it. In particular, the communication control I/F 11 sends and receives quality measurement packets to and from the receiving probe 20, and sends and receives data and the like necessary for establishment and close of a session by SIP to and from the SIP server 30.

The maintenance communication control I/F 12 controls communication regarding various pieces of information between it and the voice quality measurement server 60 as well as the client 70 connected to it. In particular, the maintenance communication control I/F 12 receives scenarios from the voice quality measurement server 60 and sends measurement results to it.

The memory unit 14 stores data and programs necessary for various processes by the control unit 13 and includes the sent packet counter memory unit 14a, the received packet maximum value counter memory unit 14b and the returned packet counter memory unit 14c which are particularly related closely to the invention.

The sent packet counter memory unit 14a stores sent packet count of quality measurement packets, which are sent to the receiving probe 20. In particular, the sent packet counter memory unit 14a stores, as shown in FIG. 4, the sent packet counter (S) that is incremented every time a quality measurement packet is sent.

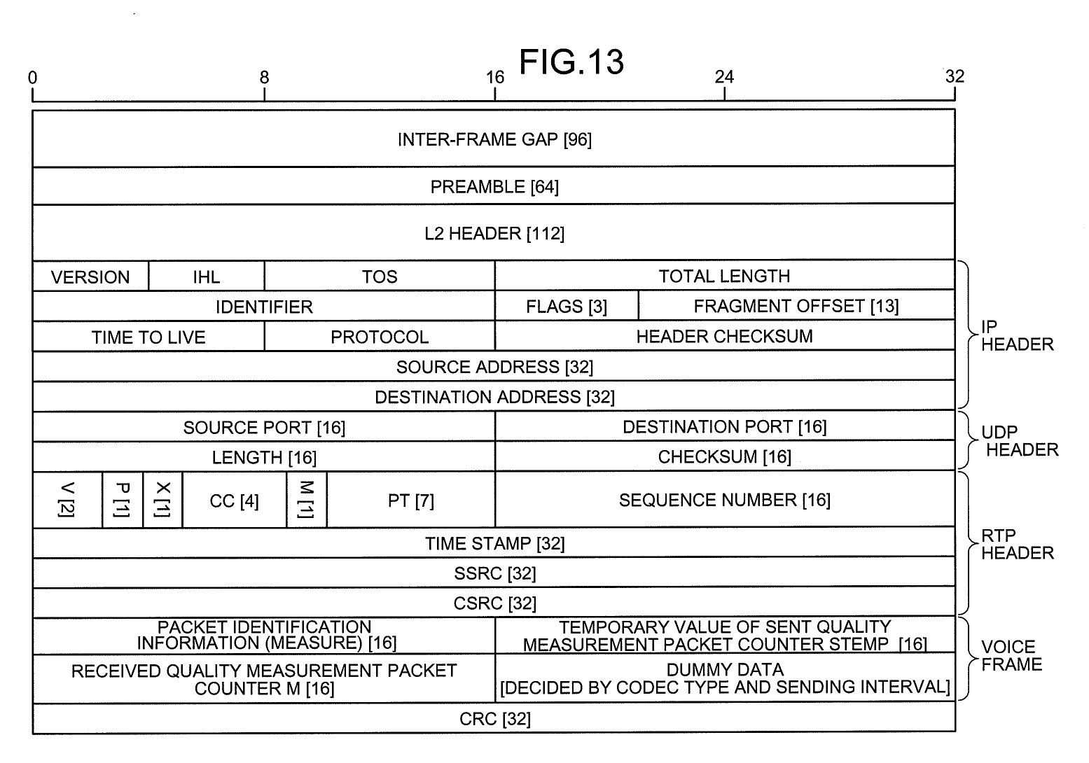

The received packet maximum value counter memory unit 14b stores the maximum value of received packet count of quality measurement packets received from the sending probe 10. In particular, the received packet maximum value counter memory unit 14b stores, as shown in FIG. 5, the maximum value of the received quality measurement packet counter M within quality measurement packets received from the receiving probe 20 (see FIG. 13).

The returned packet counter memory unit 14c stores returned packet count of quality measurement packets returned from the receiving probe 20. In particular, the returned packet counter memory unit 14c stores, as shown FIG. 6, the returned packet counter (R) that is incremented every time a quality measurement packet returned from the receiving probe 20 is received.

The control unit 13 includes an internal memory to store necessary data and programs which specify various processing procedures, and is a processing unit for various processes by using these programs and data, and also includes a SIP protocol unit 13a, a scenario control unit 13b, a measurement packet sending unit 13c, a sent packet counter incrementing unit 13d, a measurement packet extracting unit 13e, a returned packet counter incrementing unit 13f, a measured loss rate calculation unit 13g as particularly closely related to the invention. The measurement packet sending unit 13c corresponds to the “measurement packet sending unit” set forth in the claims, the sent packet counter incrementing unit 13d corresponds to the “sent packet counter incrementing unit” set forth in the claims, the measurement packet extracting unit 13e corresponds to the “measuring packet extracting unit” set forth in the claims, the returned packet counter incrementing unit 13f corresponds to the “returned packet counter incrementing unit” set forth in the claims, and the measured loss rate calculation unit 13g corresponds to the “measured loss rate calculation unit” set forth in the claims.

The SIP protocol unit 13a performs registering between the receiving probe 20 and the SIP server 30, establishes a session by a SIP, and closes the session.

Referring to FIG. 7, REGISTER is explained in detail. The SIP protocol unit 13a sends REGISTER to the SIP server 30 as shown in FIG. 7 and receives “200 OK” from the SIP server 30 so that sending and receiving via the SIP server 30 become possible. This is a similar way to use REGISTER that is applied in IP telephone, and necessary settings for the REGISTER such as the address and port number of the SIP server 30, own SIP URI, and Contact Address are set beforehand in the sending probe 10 and the receiving probe 20 respectively, so that registering to the SIP server 30 is performed according to these settings.

Referring to FIG. 8, establishing a session by a SIP is explained in detail. When the scenario control unit 13b, which is described later, receives a scenario from the voice quality measurement server 60, as shown in FIG. 8, the SIP protocol unit 13a waits until the measurement start time and at the measurement start time it receives from the scenario control unit 13b SIP-URI and type of voice codec to access the receiving probe 20 and sends a INVITEw/SDP message in which these information are set to the receiving probe 20 via the SIP server 30. The SIP protocol unit 13a receives from the SIP server 30 a tentative response 100 TRYING, which notifies that INVITE is active, and a tentative response 180 RINGING, which shows ringing, is active.

The SIP protocol unit 13a receives a response from the receiving probe 20, notifies the response to the scenario control unit 13b together with the IP address and the port number for voice packet reception of the receiving probe 20 obtained from 2000 Kw/SDP message, and sends ACK response (acknowledge to establishment of a session) to the receiving probe 20 via the SIP server 30.

Referring to FIG. 9, closing a session by a SIP is explained in detail. The SIP protocol unit 13a, as shown in FIG. 9, sends BYE message to the receiving probe 20 via the SIP server 30 to close a session, and after receiving ACK response (acknowledge of establishment of the session) via the receiving probe 20 to the SIP server 30, it closes the session.

The scenario control unit 13b receives a scenario from the voice quality measurement server 60 and indicates predetermined process according to the received scenario. In particular, the scenario control unit 13b receives a data, which contains measurement start time, SIP-URI to access to the receiving probe 20, port number to receive voice packets, type of voice codec, sending interval of voice packets, and number of sent voice packets, as a scenario from the voice quality measurement server 60. When the scenario control unit 13b receives a response from the SIP protocol unit 13a together with IP address and port number to receive voice packets from the receiving probe 20, the scenario control unit 13b notifies the IP address, port number, and the contents of the scenario to the measurement packet sending unit 13c, which is described later, and indicates it to start quality measurement.

The measurement packet sending unit 13c sends quality measurement packets to the receiving probe 20. In particular, on receiving the indication from the scenario control unit 13b to start measurement, the measurement packet sending unit 13c sets the value of the sent packet counter (S) stored in the sent packet counter memory unit 14a, the maximum value of the received packet counter (Mmax) stored in the received packet maximum value counter memory unit 14b, and the value of the returned packet counter (R) stored in the returned packet counter memory unit 14c to zero respectively. The measurement packet sending unit 13c indicates the measurement packet extracting unit 13e to prepare to receive quality measurement packets and to start a timer.

The measurement packet sending unit 13c calculates payload size of RTP packets, that are sent as quality measurement packets, from the codec type and the sending interval, generates RTP packets having the same RTP payload size as pseudo-voice packets, and describes packet identification information that identifies quality measurement packets on the RTP payload of the pseudo-voice packets and then starts sending quality measurement packets to the receiving probe 20. A character string of “MEASURE” in ASCII code is used as identification information that identifies quality measurement packets as shown in FIG. 10.

The measurement packet sending unit 13c makes decision whether quality measurement packets as many as voice packets to be sent specified in the scenario have been sent to the receiving probe 20, and if it is decided that quality measurement packets as many as voice packets to be sent have not been sent to the receiving probe 20, it performs sending process as if all specified quality measurement packets have not been sent. If it is decided that quality measurement packets as many as voice packets to be sent have been sent to the receiving probe 20, the sending process is terminated because all specified number of quality measurement packets have been sent. The measurement packet sending unit 13c sets sequence number and time stamp on RTP header, which is necessary for RTP packet, every time sending is made.

The sent packet counter incrementing unit 13d increments sent packet counter (S) every time a quality measurement packet is sent. In particular, the sent packet counter incrementing unit 13d increments the sent packet counter (S) stored in the sent packet counter memory unit 14a by one every time a quality measurement packet is sent. The value of the sent packet counter (S) is entered on RTP payload, as a temporary value of sent counter for quality measurement, Stemp.

The measurement packet extracting unit 13e receives quality measurement packets sent back from the receiving probe 20, extracts from the quality measurement packets the received packet count that indicates packet count received by the receiving probe 20, and stores it as the maximum value of received packet count of quality measurement packets in the received packet maximum value counter memory unit 14b.

In particular, the measurement packet extracting unit 13e extracts the received quality measurement packet counter (M) (see FIG. 13) from the RTP payload of quality measurement packets returned from the receiving probe 20, compares the value with the maximum value of the received packet counter Mmax stored in the received packet maximum value counter memory unit 14b, and if the received quality measurement packet counter M is greater than the maximum value of the received counter Mmax, then updates the maximum value of the received packet counter Mmax stored in the received packet maximum value counter memory unit 14b with the value of the extracted received quality measurement packet counter (M).

The measurement packet extracting unit 13e includes a timer to decide whether all quality measurement packets have been received. The timer is activated when preparation for receipt is indicated and is reset every time a RTP packet is received. Time-out time is pre-set on the timer taking arrival delay of RTP packet under assumed load condition of the network in consideration. The measurement packet extracting unit 13e decides with the time-out of the timer that all possible quality measurement packets have been received from the sending probe 10 and terminates receiving RTP packets.

The returned packet counter incrementing unit 13f increments the returned packet counter (R) stored in the returned packet counter memory unit 14c every time a quality measurement packet returned by the receiving probe 20 is received. In particular, the returned packet counter incrementing unit 13f inspects the packet identification information described in the RTP payload returned by the receiving probe 20, and when “MEASURE” identifying quality measurement packet is included, then increments the returned packet counter (R) stored in the returned packet counter memory unit 14c by “1”.

The measured loss rate calculation unit 13g, after receiving all quality measurement packets, calculates packet loss rate by using the difference between the sent packet counter (S) stored in the sent packet counter memory unit 14a and the extracted received packet counter (M) and the difference between the extracted received packet counter (M) and the returned packet counter (R) stored in the returned packet counter memory unit 14c.

In particular, after the measurement packet extracting unit 13e terminated receiving quality measurement packets, the measured loss rate calculation unit 13g reads out the sent packet counter (S), the maximum value of the received quality measurement packet counter Mmax, and the returned packet counter (R) from the sent packet counter memory unit 14a, the received packet maximum value counter memory unit 14b, and the returned packet counter memory unit 14c respectively. The measured loss rate calculation unit 13g substitutes the maximum value of the received quality measurement packet counter to the received packet counter (M), and calculates packet loss rate in the forward path by dividing the difference between the sent packet counter (S) and the received packet counter (M) by the sent packet counter (S), ((S−M)/S).

The measured loss rate calculation unit 13g calculates also packet loss rate in the backward path by dividing the difference between the received packet counter (M) and the returned packet counter (R) by the received packet counter (M), ((M−R)/M). The measured loss rate calculation unit 13g then sends the packet loss rate in the forward path and the packet loss rate in the backward path to the voice quality measurement server 60 via the maintenance network 50.

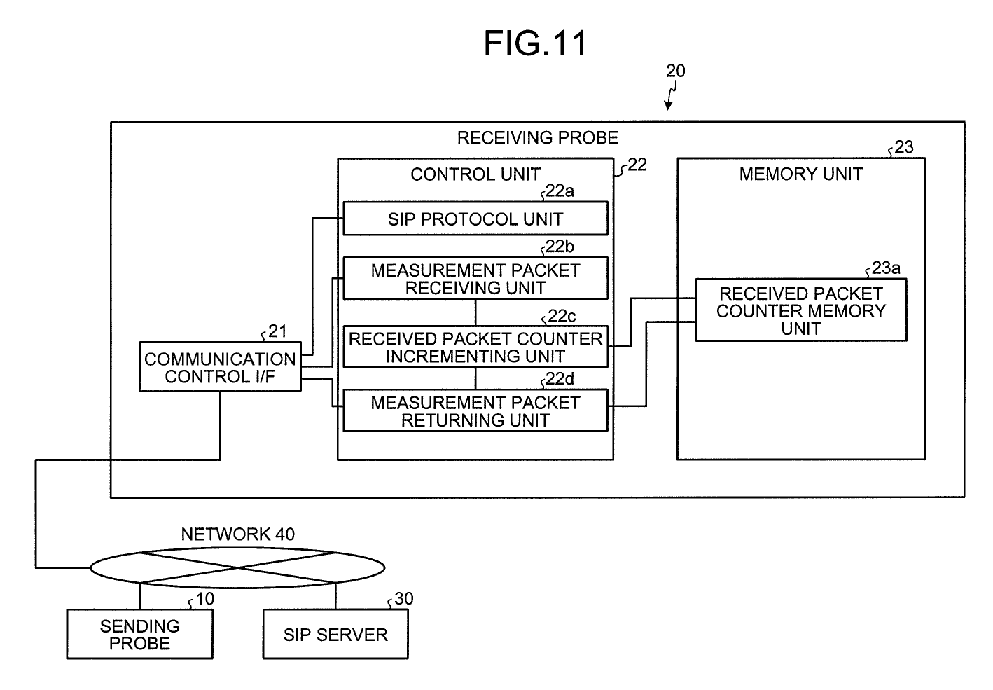

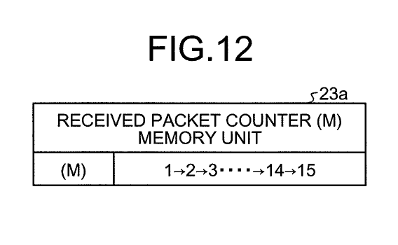

Referring to FIGS. 11 to 13, a structure of the receiving probe shown in FIG. 1 is described. FIG. 11 is a block diagram of a structure of the receiving probe according to the first embodiment, FIG. 12 is a diagram for explaining of the received packet counter memory unit, and FIG. 13 is a diagram for explaining of a structure of the quality measurement packet in the backward path.

The receiving probe 20 includes a communication control I/F 21, a control unit 22, and a memory unit 23 as shown in FIG. 11, and is connected to the sending probe 10 and the SIP server 30 via the network 40. Processes performed in each unit are described below.

The communication control I/F 21 controls communication regarding various information sent and received to and from the sending probe 10 and the SIP server 30 connected to it. In particular, the communication control I/F 21 sends and receives quality measurement packets to and from the sending probe 10, and sends and receives data necessary to establish a session and data necessary to terminate the session to and from the SIP server 30.

The memory unit 23 stores data and programs necessary for various processes by the control unit 22 and includes the received packet counter memory unit 23a especially related closely to the invention.

The received packet counter memory unit 23a stores received packet count of quality measurement packets received from the sending probe 10. In particular, the received packet counter memory unit 23a stores the received packet counter (M), which is incremented every time a quality measurement packet is received as shown in FIG. 12.

The control unit 22 has an internal memory to store programs specifying various process procedures and necessary data, is a processing unit by using these to perform various processes, and includes a SIP protocol unit 22a, a measurement packet receiving unit 22b, a received packet counter incrementing unit 22c, and a measurement packet returning unit 22d all of which are especially related to closely to the invention. The measurement packet receiving unit 22b corresponds to the “measurement packet receiving unit” set forth in the claims, the received packet counter incrementing unit 22c corresponds to the “received packet counter incrementing unit” set forth in the claims, and the measurement packet returning unit 22d corresponds to the “measurement packet returning unit” set forth in the claims.

The SIP protocol unit 22a performs registering between the receiving probe 20 and the SIP server 30, establishes and terminates a session by SIP (see FIGS. 7 to 9).

The measurement packet receiving unit 22b receives quality measurement packets sent by the sending probe 10. In particular, the measurement packet receiving unit 22b receives quality measurement packets sent by the sending probe 10, inspects packet identification information in the received quality measurement packets, and when it is “MEASURE” then notifies it to the received packet counter incrementing unit 22c which is described in detail below.

The received packet counter incrementing unit 22c increments the received packet counter (M) stored in the received packet counter memory unit 23a every time a quality measurement packet is received. In particular, on receiving the notice from the measurement packet receiving unit 22b that the packet identification information is “MEASURE”, the received packet counter incrementing unit 22c increments the received packet counter (M) stored in the received packet counter memory unit 23a by “1”. Then the received packet counter incrementing unit 22c notifies RTP payload size of the received quality measurement packets, temporary value Stemp of sent quality measurement packet counter in RTP payload, “MEASURE” that identifies, as packet identification information, a quality measurement packet, and the value of the received quality measurement packet counter (M) to the measurement packet returning unit 22d.

The measurement packet returning unit 22d attaches the received packet counter (M) stored in the received packet counter memory unit 23a to the quality measurement packet and returns this to the sending probe 10 every time a quality measurement packet is received.

In particular, the measurement packet returning unit 22d receives RTP payload size of quality measurement packets, temporary value Stemp of sent quality measurement packet counter in RTP payload, “MEASURE” that identifies, as packet identification information, quality measurement packets, and a value indicated by the received quality measurement packet counter (M) from the received packet counter incrementing unit 22c, then generates a RTP packet for the sending probe 10. The measurement packet returning unit 22d enters packet identification information “MEASURE” on quality measurement packets in the backward path as exemplarily shown in FIG. 13, and also enters the value of received packet counter for quality measurement (M) (received packet counter for quality measurement M “16” for example in FIG. 13). Then the measurement packet returning unit 22d enters other necessary header information (such as sequence number and time stamp) on the generated RTP packet and sends quality measurement packets to the sending probe 10 via the network 40.

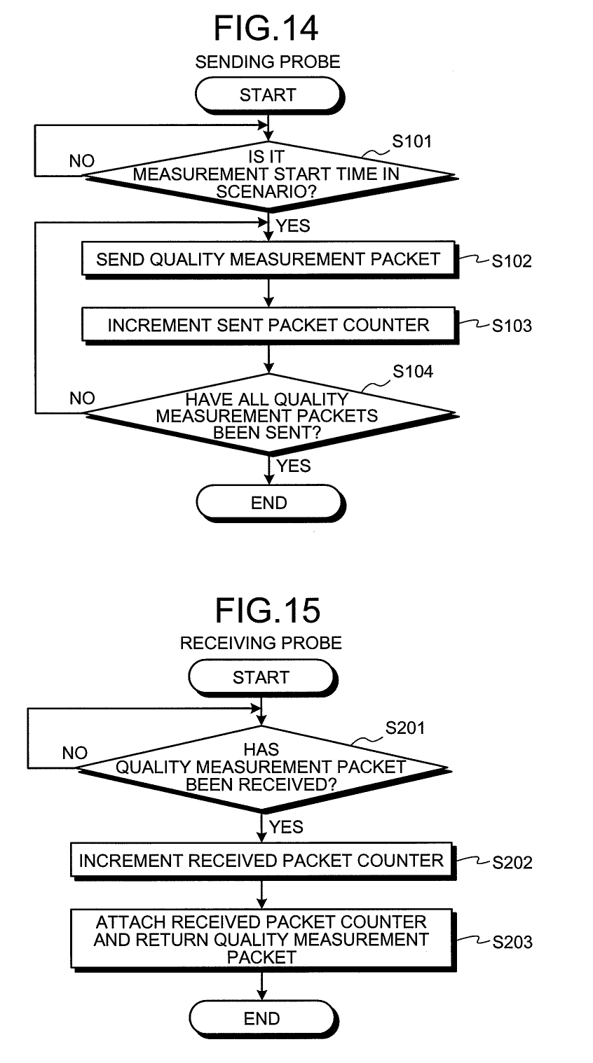

Referring to FIG. 14, a quality measurement packet sending process by the sending probe 10 according to the first embodiment is described. FIG. 14 is a flowchart of sending process procedure of the sending probe 10 according to the first embodiment.

As shown in FIG. 14, on receiving a scenario for measurement (for example, measurement start time) from the voice quality measurement server 60 (Yes at step S101), the measurement packet sending unit 13c of the sending probe 10 waits until the measurement start time in the scenario, and then sends quality measurement packets to the receiving probe 20 at the measurement start time (step S102).

Then the sent packet counter incrementing unit 13d increments the sent packet counter (S) stored in the sent packet counter memory unit 14a every time a quality measurement packet is sent (step S103).

The measurement packet sending unit 13c decides whether quality measurement packets as many as sent voice packets specified in the scenario have been sent to the receiving probe 20 (step S104), and when it is decided that not all specified number of quality measurement packets have been sent to the receiving probe 20 (No at step S104), then sending process is performed as if all specified number of quality measurement packets have not been sent (step S102). When it is decided that quality measurement packets as many as sent voice packets have been sent (Yes at step S104), the measurement packet sending unit 13c terminates the sending process because all specified number of quality measurement packets have been sent.

Referring to FIG. 15, quality measurement packet returning process by the receiving probe 20 according to the first embodiment is described. FIG. 15 is a flowchart of a returning process procedure of the receiving probe 20 according to the first embodiment.

As shown in FIG. 15, on receiving quality measurement packets sent by the sending probe 10 (Yes at step S201), the measurement packet receiving unit 22b of the receiving probe 20 increments the received packet counter (M) stored in the received packet counter memory unit 23a (step S202) every time a quality measurement packet is received, and attaches the received packet counter (M) stored in the received packet counter memory unit 23a to the quality measurement packet every time a quality measurement packet is received and sends it to the sending probe 10 (step S203).

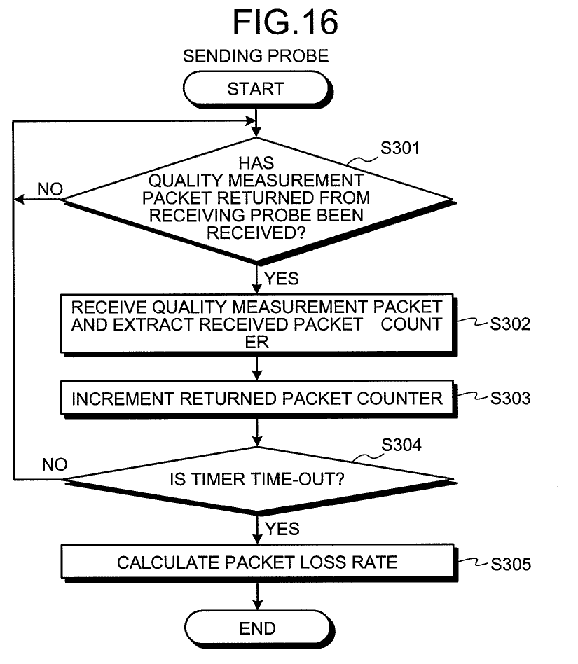

Referring to FIG. 16, a packet loss rate calculation process by the sending probe 10 according to the first embodiment is described. FIG. 16 is a flowchart of calculation process procedure of the sending probe 10 according to the first embodiment.

As shown in FIG. 16, on receiving quality a measuring packets returned from the receiving probe 20 (Yes at step S301), the measurement packet extracting unit 13e of the sending probe 10 extracts from the quality measurement packets the received packet count that shows packet count which the receiving probe 20 has received, and stores it in the received packet maximum value counter memory unit 14b as the maximum value of received packet count of quality measurement packets (step S302).

The returned packet counter incrementing unit 13f increments the returned packet counter (R) stored in the returned packet counter memory unit 14c every time a quality measurement packet is received returned from the receiving probe 20 (step S303). Then the measurement packet extracting unit 13e decides whether time-out of the timer occurs (step S304), and if time-out has not occur (No at S304), receives quality measurement packets returned from the receiving probe 20 (step S301). If the measurement packet extracting unit 13e decides that time-out of the timer occurred (Yes at step S304), then the measured loss rate calculation unit 13g calculates packet loss rate in the forward path by dividing the difference between the sent packet counter (S) and the received packet counter (M) by the sent packet counter (S), ((S−M)/S), and calculates packet loss rate in the backward path by dividing the difference between the received packet counter (M) and the returned packet counter (R) by the received packet counter (M), ((M−R)/M) (step S305).

The packet loss rate with high accuracy in a forward path as well as in a backward path can be calculated as described above, because the sending probe 10 stores sent packet count of quality measurement packets sent to the receiving probe 20, stores returned packet count of quality measurement packets returned from the receiving probe 20, sends quality measurement packets to the receiving probe 20, increments stored sent packet count every time a quality measurement packet is sent, receives quality measurement packets returned from the receiving probe 20, extracts from the quality measurement packets the received packet count which indicates received packet count from the receiving probe 20, increments stored returned packet count every time a quality measurement packet returned from the receiving probe is received, calculates packet loss rate by using the difference between the stored sent packet count and the extracted received packet count, and the difference between the extracted received packet count and the stored returned packet count, and the receiving probe 20 stores received packet count of quality measurement packets received from the sending probe 10, receives sent quality measurement packets, increments stored received packet count every time a quality measurement packet is received, and, every time quality a measurement packet is received, attaches the stored received packet count to the quality measurement packet and returns this to the sending probe 10.

In the first embodiment, a measurement confirmation packet may be sent to the receiving probe to confirm measurement result at the receiving probe after the sending probe has sent all quality measurement packets to the receiving probe.

In a second embodiment of the present invention where a sending probe sends a measurement confirmation packet to a receiving probe, an outline and features of a packet loss rate calculation system, a structure of the packet loss rate calculation system and a flow of a process according to the second embodiment are successively described, and then the effect according to the second embodiment will be described.

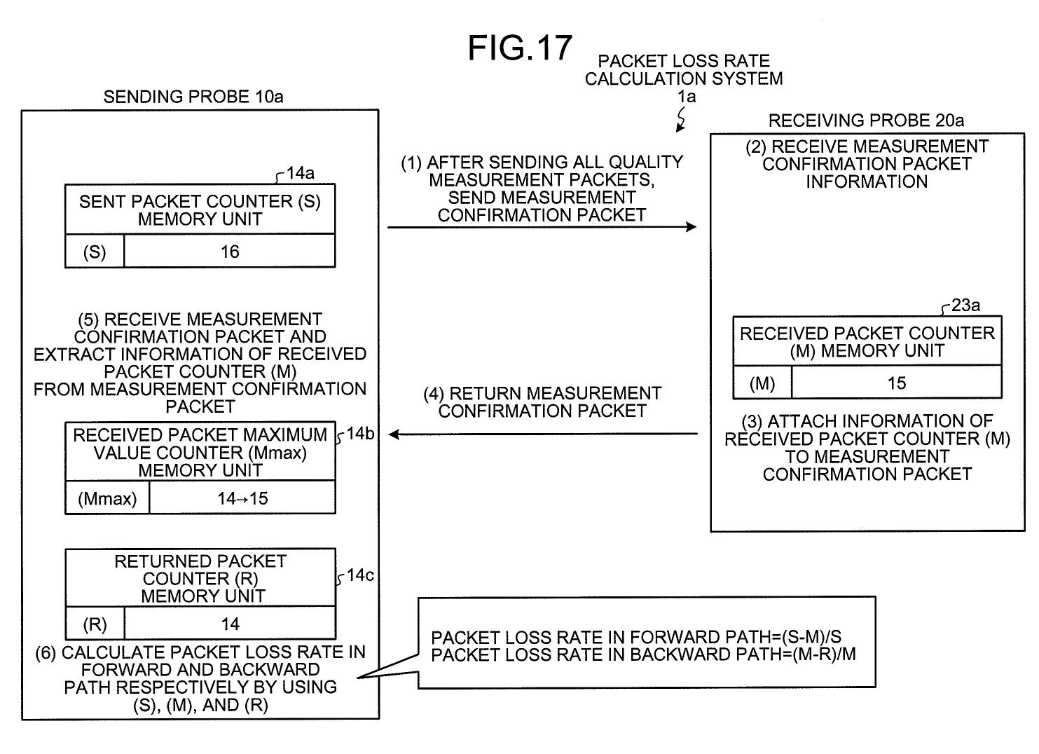

Referring to FIG. 17, an outline and features of a packet loss calculation system according to the second embodiment are described. FIG. 17 is a diagram for explaining an outline and features of a packet loss rate calculation system 1a according to the second embodiment.

In the packet loss rate calculation system 1a according to the second embodiment, a measurement confirmation packet is sent and received between a sending probe 10a and a receiving probe 20a, and packet loss rate between the measuring points is calculated by using the information obtained from the measurement confirmation. The packet loss rate calculation system 1a features in that, even when the last quality measurement packet sent from the sending probe to the receiving probe was lost, the packet loss rate can be calculated by sending the received packet count stored in the receiving probe again at the end of quality measurement.

Describing the main feature specifically, as shown in FIG. 17, the sending probe 10a of the packet loss rate calculation system 1a further sends a measurement confirmation packet to the receiving probe 20a after all quality measurement packets have been sent to the receiving probe 20a (see FIG. 17 (1)).

The receiving probe 20a receives the measurement confirmation packet sent by the sending probe 10a (see FIG. 17 (2)), attaches the received packet counter (M) stored in the received packet counter memory unit 23a at the present moment to the quality confirmation packet (see FIG. 17 (3)), and returns it to the sending probe 10a (see FIG. 17 (4)).

The sending probe 10a then receives the measurement confirmation packet returned from the receiving probe 20a, and extracts from the measurement confirmation packet the received packet count that indicates packet count received by the receiving probe 20a (see FIG. 17 (5)). If the extracted received packet count is greater than the received packet count stored in the received packet maximum value counter memory unit 14b as the maximum value of received packet count of quality measurement packets, then the sending probe 10a stores the extracted received packet count in the received packet maximum value counter memory unit 14b as the maximum value of received packet count of quality measurement packets.

The sending probe 10a calculates packet loss rate by using the difference between the sent packet counter (S) stored in the sent packet counter memory unit 14a and the extracted received packet counter (M), and the difference between the extracted received packet counter (M) and the returned packet counter (R) stored in the returned packet counter memory unit 14c (see FIG. 17 (6)).

Thus, the main features of the packet loss rate calculation system 1a is in that packet loss rate is calculated at the end of quality measurement by sending received packet count stored in the receiving probe 20a again at the end of the quality measurement even when the last quality measurement packet sent from the sending probe 10a to the receiving probe 20a is lost.

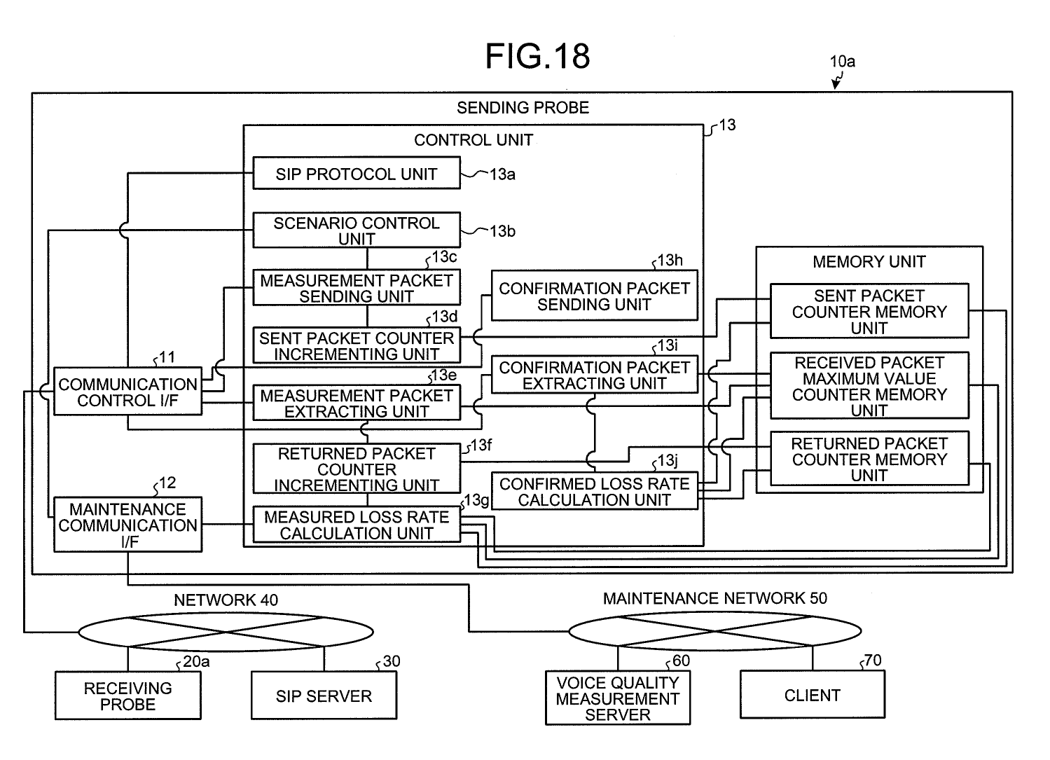

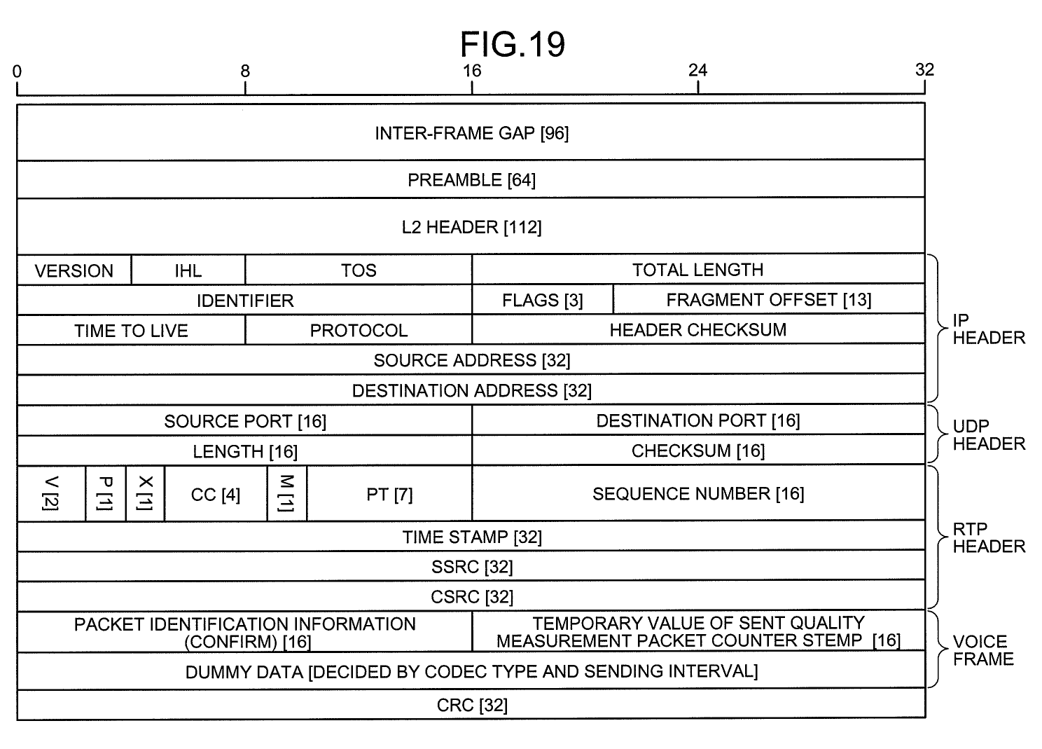

Referring to FIGS. 18 and 19, a structure of the sending probe shown in FIG. 17 is described. FIG. 18 is a block diagram of a structure of the sending probe according to the second embodiment and FIG. 19 is a diagram of a structure of a measurement packet in the forward path.

As shown in FIG. 18, the sending probe 10a is different from the sending probe 10 shown in FIG. 1 in additionally including a confirmation packet sending unit 13h, a confirmation packet extracting unit 13i and a confirmed loss rate calculation unit 13j.

The confirmation packet sending unit 13h sends a measurement confirmation packet to the receiving probe 20a after sending all quality measurement packets to the receiving probe 20a.

In particular, after all quality measurement packets specified in the scenario have been sent, the confirmation packet sending unit 13h sends a measurement confirmation packet on which packet identification information “CONFIRM” is attached, responding to a request to send a measurement confirmation packet after sending quality measurement packets in the scenario. “CONFIRM” in ASCII code is used as packet identification information to identify a measurement confirmation packet as shown in FIG. 19.

The confirmation packet extracting unit 13i receives a measurement confirmation packet returned from the receiving probe 20a and extracts from the measurement confirmation packet the packet count received by the receiving probe 20a.

In particular, the confirmation packet extracting unit 13i receives measurement confirmation packet returned from the receiving probe 20a and determines the packet identification information described in RTP payload. When the packet identification information is “CONFIRM” identifying measurement confirmation packet, the confirmation packet extracting unit 13i extracts the received packet counter for quality measurement M from RTP payload without incrementing the returned quality measurement packet counter R, compares the value with the maximum value of the received quality measurement packet counter Mmax, and if the received quality measurement packet counter M is greater than Mmax, then updates the maximum value of the received quality measurement packet counter Mmax with the value.

The confirmed loss rate calculation unit 13j calculates packet loss rate by using the difference between the sent packet counter (S) stored in the sent packet counter memory unit 14a and the extracted received packet counter (M) and the difference between the extracted received packet counter (M) and the returned packet counter (R) stored in the returned packet counter memory unit 14c.

In particular, after the confirmation packet extracting unit 13i has stopped receiving measurement confirmation packets, the confirmed loss rate calculation unit 13j calculates packet loss rate in the forward path by dividing the difference between the sent packet counter (S) and the received packet counter (M) by the sent packet counter (S), ((S−M)/S). The confirmed loss rate calculation unit 13j also calculates packet loss rate in the backward path by dividing the difference between the received packet counter (M) and the returned packet counter (R) by the received packet counter (M), ((M−R)/M). Then the confirmed loss rate calculation unit 13j sends the packet loss rate in the forward path and the packet loss rate in the backward path to the voice quality measurement server 60 via the maintenance network 50.

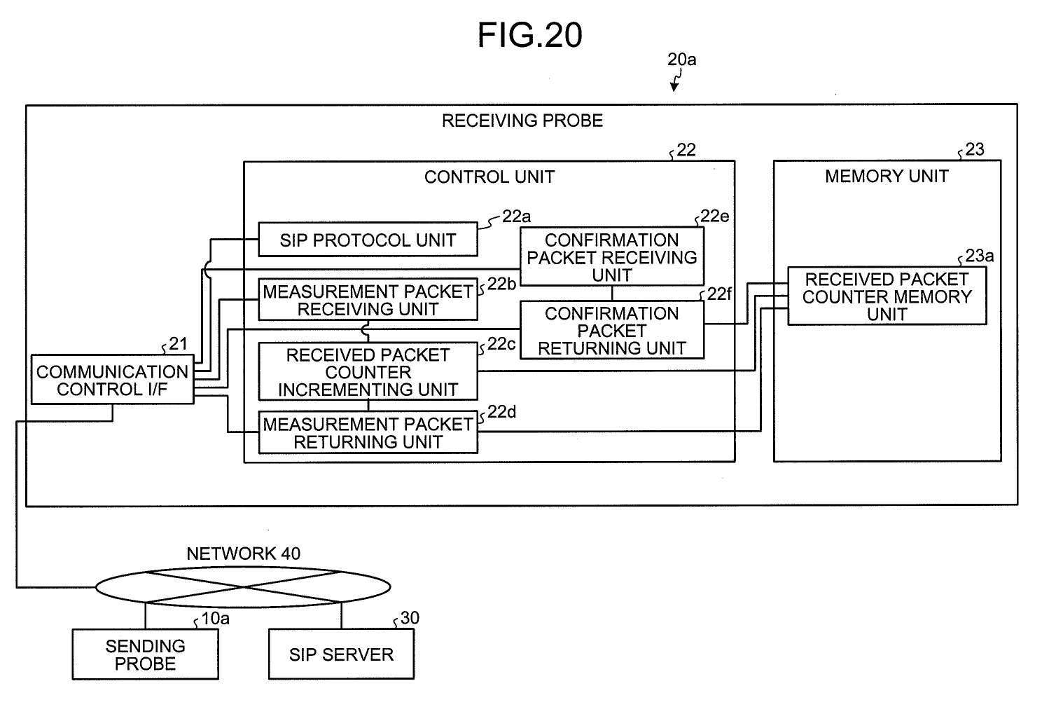

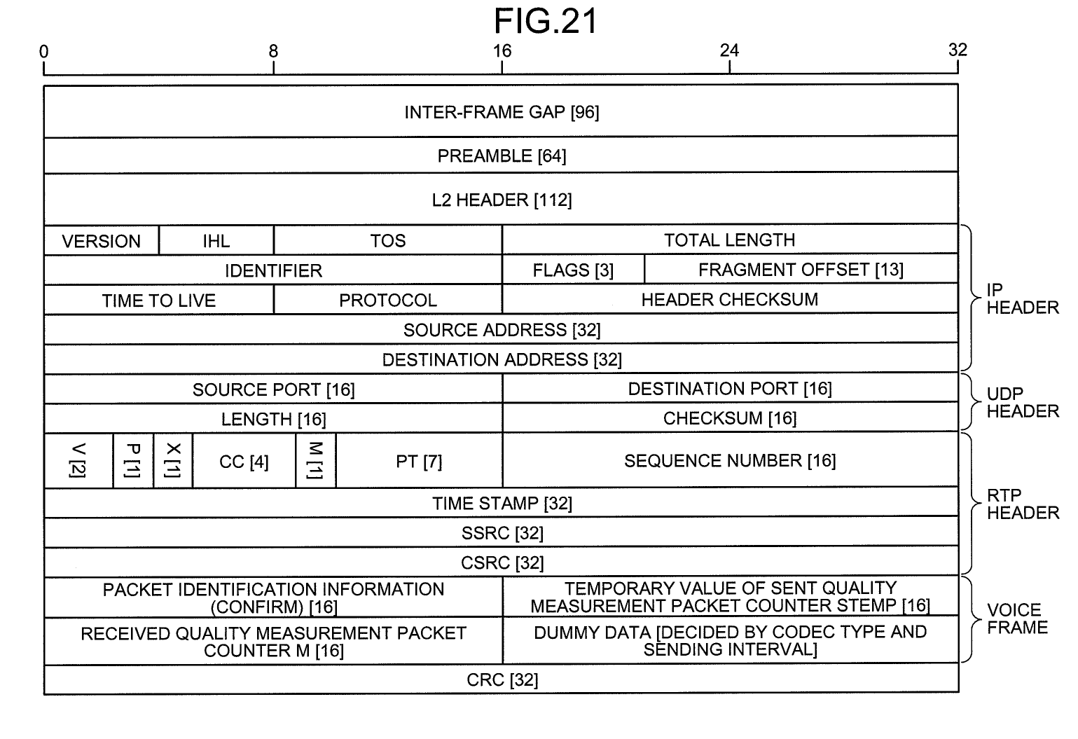

Referring to FIGS. 20 and 21, the structure of the receiving probe shown in FIG. 17 is described. FIG. 20 is a block diagram of a structure of the sending probe according to the second embodiment and FIG. 21 is a diagram of a structure of a measuring packet in the forward path.

As shown in FIG. 20, the receiving probe 20a is different from the receiving probe 20 in additionally including a confirmation packet receiving unit 22e and a confirmation packet returning unit 22f.

The confirmation packet receiving unit 22e receives a measurement confirmation packet sent by the sending probe 10a. In particular, the confirmation packet receiving unit 22e receives a measurement confirmation packet sent by the sending probe 10a, inspects packet identification information in the received quality measurement packets, and when it is “CONFIRM”, then notifies it to the confirmation packet returning unit 22f described in detail later.

Every time a measurement confirmation packet is received, the confirmation packet returning unit 22f attaches the received packet counter (M) stored in the received packet counter memory unit 23a to the measurement confirmation packet and returns it to the sending probe 10a.

In particular, on receiving notification indicating that packet identification information is “CONFIRM” from the confirmation packet receiving unit 22e, the confirmation packet returning unit 22f skips incrementing process of received quality measurement packet counter because it is not a quality measurement packet, and generates a measurement confirmation packet by using payload size of the received RTP packet, the temporary value Stemp of the sent quality measurement packet counter in RTP payload, packet identification information (in this case “CONFIRM”), and the value indicated by the received quality measurement packet counter M (see FIG. 21). The confirmation packet returning unit 22f enters other necessary information (such as sequence number and time stamp) on the generated RTP packet, and then returns the quality measurement packet to the sending probe 10a via the network 40.

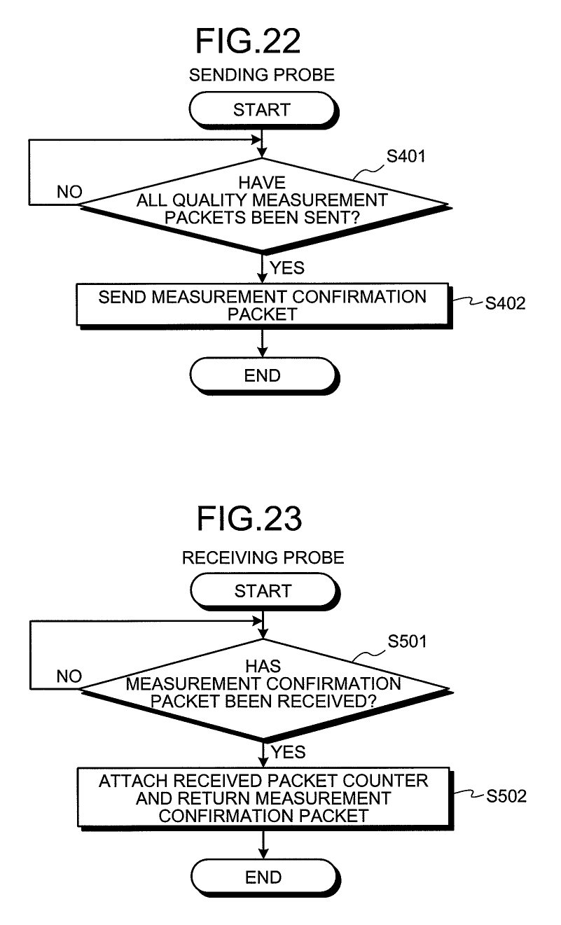

Referring to FIG. 22, a measurement confirmation packet sending process by the sending probe 10a according to the second embodiment is described. FIG. 22 is a flowchart of a sending process by the sending probe 10a according to the second embodiment.

As shown in FIG. 22, the confirmation packet sending unit 13h of the sending probe 10a, after sending all quality measurement packets to the receiving probe 20a (Yes at step S401), sends a measurement confirmation packet to the receiving probe 20a (step S402).

Referring to FIG. 23, a measurement confirmation packet returning process by the receiving probe 20a according to the second embodiment is described. FIG. 23 is a flowchart of a returning process procedure by the receiving probe according to the second embodiment.

As shown in FIG. 23, when the confirmation packet receiving unit 22e of the receiving probe 20a has received a measurement confirmation packet sent by the sending probe 10a (Yes at step S501), the confirmation packet returning unit 22f attaches the received packet counter (M) stored in the received packet counter memory unit 23a to the measurement confirmation packet and returns it to the sending probe 10a (step S502). (Packet loss rate calculation process by the sending probe 10a according to the second embodiment)

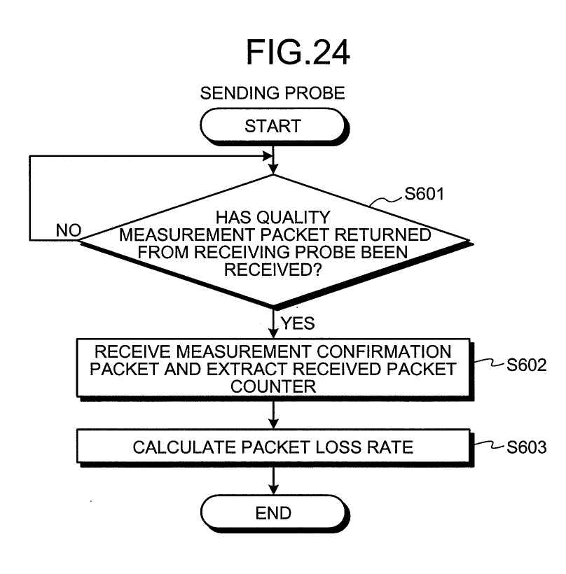

Referring to FIG. 24, a packet loss rate calculation process by the sending probe 10a according to the second embodiment is described. FIG. 24 is a flowchart of a calculation process procedure of the sending probe 10a according to the second embodiment.

As shown in FIG. 24, when a measurement confirmation packet returned from the receiving probe 20a is received (Yes at step S601), the confirmation packet extracting unit 13i of the sending probe 10a extracts from the measurement confirmation packet the packet count received by the receiving probe 20a, stores it in the received packet maximum value counter memory unit 14b as the maximum value of received packet count of quality measurement packets (step S602).

The confirmed loss rate calculation unit 13j calculates packet loss rate in the forward path by dividing the difference between the sent packet counter (S) and the received packet counter (M) by the sent packet counter (M), ((S−M)/s), and calculates packet loss rate in the backward path by dividing the difference between the received packet counter (M) and the returned packet counter (R) by the received packet counter (M), ((M−R)/M) (step S603).

Thus even when the last quality measurement packet sent from the sending probe 10a to the receiving probe 20a was lost, packet loss rate at the end of quality measurement can be calculated by sending received packet count stored in the receiving probe 20a again at the end of the quality measurement, because after sending all quality measurement packets to the receiving probe 20a, the sending probe 10a further sends a measurement confirmation packet to the receiving probe 20a to confirm measurement result by the receiving probe 20a, receives the measurement confirmation packet returned from the receiving probe 20a, extracts received packet count from the measurement confirmation packet, calculates packet loss rate by using the difference between the stored sent packet count and the extracted received packet count, and the difference between the extracted received packet count and the stored returned packet count, and the receiving probe 20a receives the sent measurement confirmation packet, and after receiving the measurement confirmation packet, attaches the stored received packet count to the measurement confirmation packet and returns it to the sending probe 10a.

In the first embodiment, a measurement confirmation packet may be sent to a receiving probe to confirm measurement result by a receiving probe at any arbitrary timing during send of quality measurement packets.

In a third embodiment of the present invention where a sending probe sends a measurement confirmation packet to a receiving probe during send of quality measurement packets, an outline and features of a packet loss rate calculation system, a structure of the packet loss rate calculation system and process flow according to the third embodiment is successively described and then the effect according to the third embodiment is described.

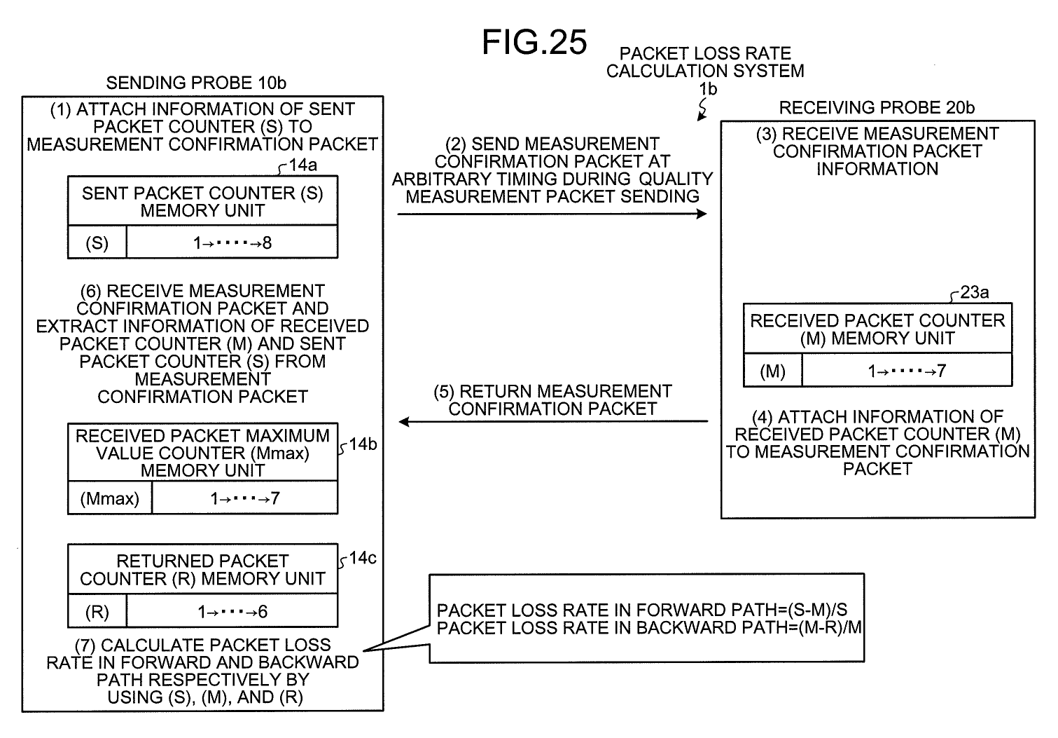

Referring to FIG. 25, an outline and features of a packet loss rate calculation system according to the third embodiment are described. FIG. 25 is a diagram of an outline and features of a packet loss rate calculation system 1b according to the third embodiment.

In the packet loss rate calculation system 1b according to the third embodiment, a measurement confirmation packet is exchanged between a sending probe 10b and a receiving probe 20b during send of quality measurement packets, and by using the information obtained from the measurement confirmation packet, packet loss rate between the measuring points at that time point is calculated. The packet loss rate calculation system 1b is mainly characterized in that, even when a quality measurement packet was lost during measurement of packet loss rate, the packet loss rate at that time point can be calculated.

Describing the feature in particular, the sending probe 10b in the packet loss rate calculation system 1b attaches a sent packet counter (S) stored in the sent packet counter memory unit 14a to a measurement confirmation packet (see FIG. 25 (1)) at arbitrary timing during send of quality measurement packets, and send the measurement confirmation packet to the receiving probe 20b (see FIG. 25 (2)).

The receiving probe 20b then receives the measurement confirmation packet sent by the sending probe 10b (see FIG. 25 (3)), attaches a received packet counter (M) stored in the received packet counter memory unit 23a at the present time (see FIG. 25 (4)), and returns it to the sending probe 10b (see FIG. 25 (5)).

The sending probe 10b receives the measurement confirmation packet returned by the receiving probe 20b, and extracts the received packet counter (M) and the sent packet counter (S) from the measurement confirmation packet (see FIG. 25 (6)).

The sending probe 10b then calculates packet loss rate by using the difference between the extracted sent packet counter (S) and the extracted received packet counter (M), and the difference between the extracted received packet counter (M) and the returned packet counter (R) stored in the returned packet counter memory unit 14c (see FIG. 25 (7)).

The packet loss rate calculation system 1b mainly features in calculating packet loss rate at that time can be calculated even when quality measurement packets were lost during measurement of packet loss rate as described features above, because the sending probe 10b sends a measurement confirmation packet to the receiving probe 20b to confirm measurement result by the receiving probe 20b at arbitrary timing during send of quality measurement packets.

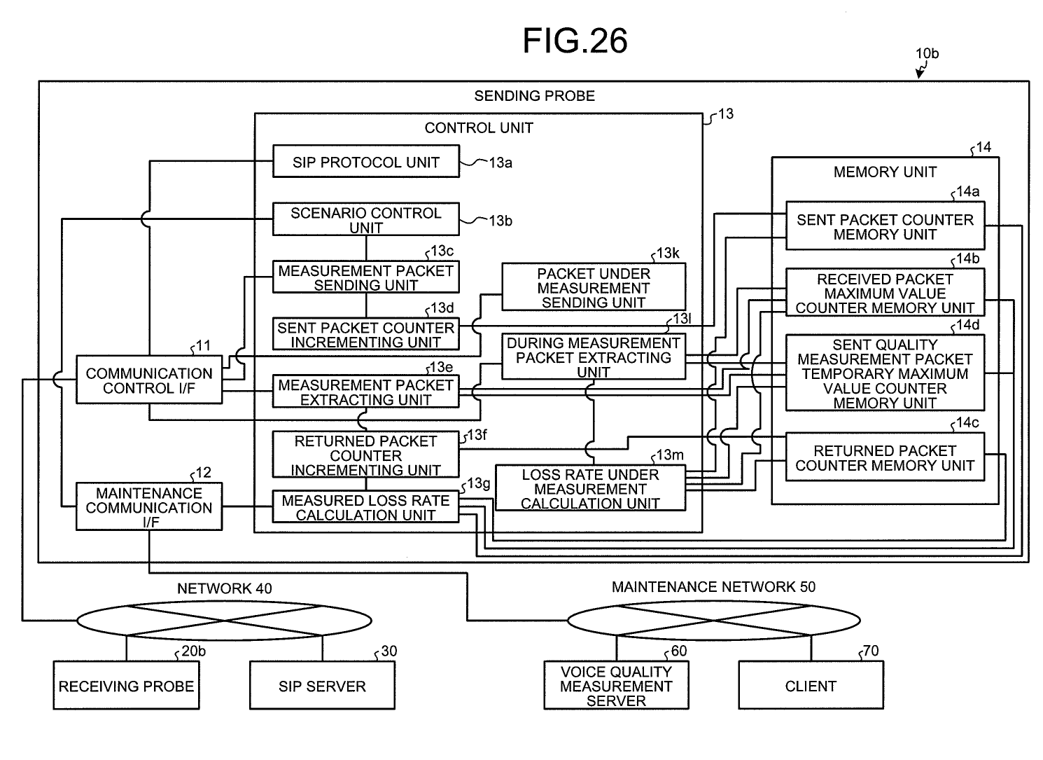

Referring to FIG. 26 a structure of the sending probe shown in FIG. 25 is described. FIG. 26 is a block diagram of the structure of the sending probe 10b according to the third embodiment.

As shown in FIG. 26, the sending probe 10b is different from the sending probe 10 shown in FIG. 3 in additionally including a sent quality measurement packet temporary maximum value counter memory unit 14d, a packet under measurement sending unit 13k, a packet under measurement extracting unit 13l and a loss rate under measurement calculation unit 13m.

The sent quality measurement packet temporary maximum value counter memory unit 14d stores the maximum value of sent quality measurement packet count sent by the sending probe 10b. In particular, the sent quality measurement packet temporary maximum value counter memory unit 14d stores the maximum value of temporary value of sent quality measurement packet counter Stemp in quality measurement packets sent to the receiving probe 20b.

The packet under measurement sending unit 13k attaches the sent packet counter (S) stored in the sent packet counter memory unit 14a to a measurement confirmation packet at an arbitrary timing during send of quality measurement packets, and sends it measurement confirmation packet to the receiving probe 20b.

In particular, the packet under measurement sending unit 13k reads out from the scenario the send-timing for a during measurement confirmation packet, which specifies to send the measurement confirmation packet at the time point when the specified number of quality measurement packets have been sent, and attaches the sent packet counter (S) as temporary value Stemp of sent quality measurement packet counter to the measurement confirmation packet, and sends it to the receiving probe 20b according to the timing read-out for sending the during measurement packet.

The packet under measurement extracting unit 13l receives the measurement confirmation packet returned from the receiving probe 20b, and the extracts received packet counter (M) and the sent packet counter (S) from the measurement confirmation packet.

In particular, the packet under measurement extracting unit 13l receives the measurement confirmation packet returned from the receiving probe 20b, and determines packet identification information described in RTP payload. When the packet identification information is “CONFIRM” identifying confirmation packet, then the packet under measurement extracting unit 13l extracts the received quality measurement packet counter M and the temporary value Stemp of sent quality measurement packet counter from RTP payload, without incrementing the returned quality measurement packet counter R.

The packet under measurement extracting unit 13l compares the extracted received quality measurement packet counter M with the maximum value of the received quality measurement packet counter Mmax stored in the received packet maximum value counter memory unit 14b, and when the received quality measurement packet counter M is greater, then the maximum value of the received quality measurement packet counter Mmax is updated with the value. Also the packet under measurement extracting unit 13l compares the extracted temporary value of sent quality measurement packet counter Stemp with the temporary maximum value of sent quality measurement packet counter Stempmax stored in the sent quality measurement packet temporary maximum value counter memory unit 14d, and when the temporary value of sent quality measurement packet counter Stemp is greater, then the temporary maximum value of sent quality measurement packet counter Stempmax is updated with the value.

The loss rate under measurement calculation unit 13m calculates by using the difference between the extracted sent packet counter (S) and the extracted received packet counter (M), and the difference between the extracted received packet counter (M) and the returned packet counter (R) stored in the returned packet counter memory unit 14c.

In particular, the loss rate under measurement calculation unit 13m reads out the temporary maximum value of sent quality measurement packet counter Stempmax, the maximum value of the received quality measurement packet counter Mmax, and the returned packet counter (R) from the sent quality measurement packet temporary maximum value counter memory unit 14d, the received packet maximum value counter memory unit 14b, and the returned packet counter memory unit 14c respectively.

The loss rate under measurement calculation unit 13m substitutes the temporary maximum value of sent quality measurement packet counter Stempmax to the sent packet counter (S) and substitutes the maximum value of the received quality measurement packet counter Mmax to the received packet counter (M), and calculates packet loss rate in the forward path by dividing the difference between the sent packet counter (S) and the received packet counter (M) by the sent packet counter (S), ((S−M)/S). The loss rate under measurement calculation unit 13m also calculates packet loss rate in the backward path by dividing the difference between the received packet counter (M) and the returned packet counter (R) by the sent packet counter (M), ((M−R)/M). Then the loss rate under measurement calculation unit 13m sends the packet loss rate in the forward path and the packet loss rate in the backward path to the voice quality measurement server 60 via the maintenance network 50.

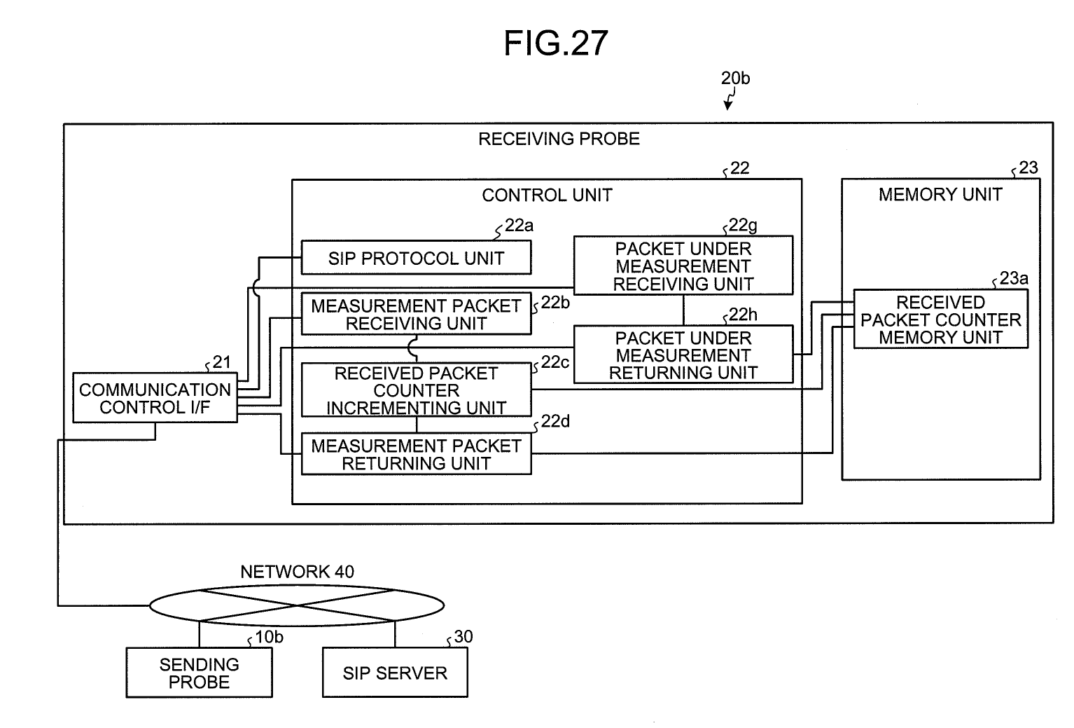

Referring to FIG. 27, the structure of the receiving probe shown in FIG. 25 is described. FIG. 27 is a block diagram of the sending probe according to the third embodiment.

As shown in FIG. 27, the receiving probe 20b is different from the receiving probe 20 shown in FIG. 11 in additionally including a packet under measurement receiving unit 22g and a packet under measurement returning unit 22h.

The packet under measurement receiving unit 22g receives a measurement confirmation packet sent by the sending probe 10b. In particular, the packet under measurement receiving unit 22g receives a measurement confirmation packet sent by the sending probe 10b, inspects packet identification information in the received quality measurement packets, and when it is “CONFIRM” then notifies it to the packet under measurement returning unit 22h.

Every time a measurement confirmation packet is received, the packet under measurement returning unit 22h attaches the received packet counter (M) stored in the received packet counter memory unit 23a to the measurement confirmation packet and returns it to the sending probe 10b.

In particular, the packet under measurement returning unit 22h, when it is notified by the packet under measurement receiving unit 22g that the packet identification information is “CONFIRM”, because it indicates no quality measurement packet, generates a measurement confirmation packet by using RTP payload size of the received RTP packet, the temporary value Stemp of the sent quality measurement packet counter in RTP payload, and packet identification information (“CONFIRM” in this case), and the value indicated by the received quality measurement packet counter M, without incrementing the received quality measurement packet counter for M. The packet under measurement returning unit 22h enters other necessary header information (such as sequence number and time stamp) on the generated RTP packet and then returns the quality measurement packet to the sending probe 10b via the network 40.

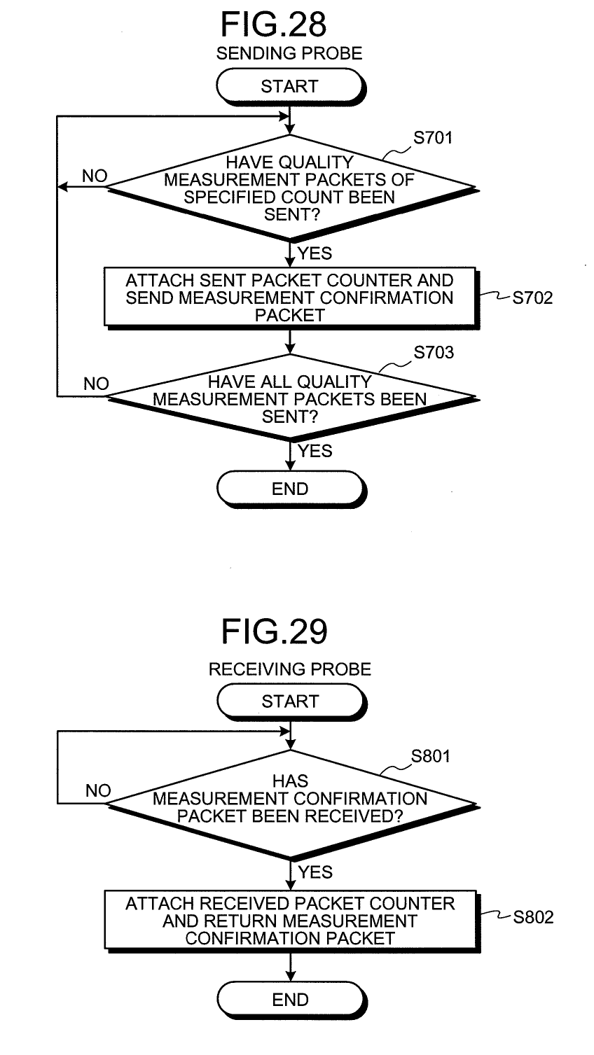

Referring to FIG. 28, a measurement confirmation packet sending process by the sending probe according to the third embodiment is described. FIG. 28 is a flowchart of a sending process procedure of the sending probe 10b according to the third embodiment.

As shown in FIG. 28, the packet under measurement sending unit 13k of the sending probe 10b has sent quality measurement packets as many times as specified depending on the send-out timing of a during measurement confirmation packet in the scenario (Yes at step S701), and then attaches the sent packet counter (S) stored in the sent packet counter memory unit 14a to the measurement confirmation packet and sends the measurement confirmation packet to the receiving probe 20b (step S702).

The packet under measurement sending unit 13k decides whether quality measurement packets as many as voice packets to be sent as specified in the scenario have been sent to the receiving probe 20 (step S703), and when it decides that quality measurement packets as many as voice packets to be sent have not been sent (No at step S703), then sending process is performed as if all specified quality measurement packets have not been sent (step S701). When it decides that quality measurement packets as many as voice packets to be sent have been sent to the receiving probe 20 (Yes at step 703), the packet under measurement sending unit 13k terminates the sending process because all specified quality measurement packets have been sent.

Referring to FIG. 29, measurement confirmation packet returning process by the receiving probe 20b according to the third embodiment is described. FIG. 29 is a flowchart of a returning process procedure of the receiving probe according to the third embodiment.

As shown in FIG. 29, when the packet under measurement receiving unit 22g of the receiving probe 20b receives a measurement confirmation packet sent by the sending probe 10b (Yes at step S801), the packet under measurement returning unit 22h attaches the received packet counter (M) stored in the received packet counter memory unit 23a to the measurement confirmation packet and returns it to the sending probe 10b (step S802).

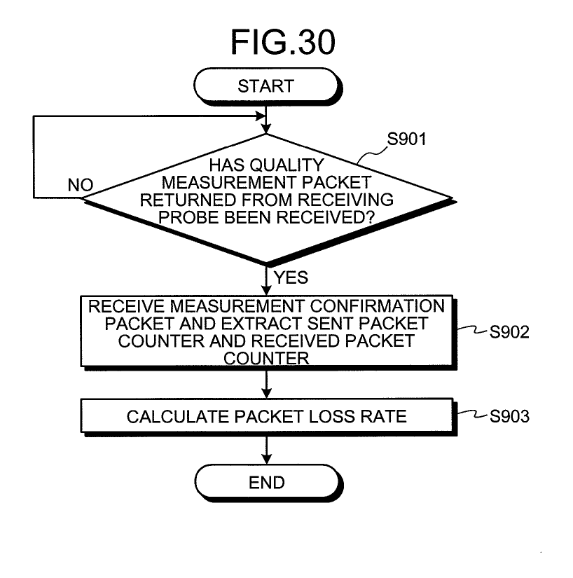

Referring to FIG. 30, a packet loss rate calculation process by the sending probe 10b according to the third embodiment is described. FIG. 30 is a flowchart of a calculation process procedure of the sending probe 10b according to the third embodiment.

As shown in FIG. 30, on receiving measurement confirmation packet returned from the receiving probe 20a (Yes at step S901), the packet under measurement extracting unit 13l of the sending probe 10b extracts the sent packet counter (M) and the sent packet counter (S) from the measurement confirmation packet (step S902).

The loss rate under measurement calculation unit 13m calculates packet loss rate by using the difference between the extracted sent packet counter (S) and the extracted received packet counter (M), and the difference between the extracted received packet counter (M) and returned packet counter (R) stored in the returned packet counter memory unit 14c (step S903).

Thus, even if quality measurement packets were lost during measurement of packet loss rate, packet loss rate at that time point can be calculated because the sending probe 10b attaches the stored sent packet count to the measurement confirmation packet to confirm measurement result of the receiving probe 20b at an arbitrary timing during send of quality measurement packets, and sends this measurement confirmation packet to the receiving probe 20b, receives the measurement confirmation packet returned from the receiving probe 20b, extracts the sent packet count and the received packet count from the measurement confirmation packet, calculates packet loss rate by using the difference between the extracted sent packet count and the extracted received packet count, and the difference between the extracted received packet count and the stored returned packet count, and the receiving probe 20b receives a sent measurement confirmation packet and when the quality measurement packet is received, attaches stored received packet count to the measurement confirmation packet, and returns it to the sending probe 10b.

The invention may be implemented in other various aspects than those embodiments described above. Another embodiment is described below as a fourth embodiment of the invention.

In the second and the third embodiments, a single measurement confirmation packet is sent at a send-out timing, but the invention is not limited to this and multiple measurement confirmation packets may be sent.

For example, the sending probe 10a sends multiple measurement confirmation packets to the receiving probe 20a after sending all quality measurement packets to the receiving probe 20a.

Packet loss rate can be calculated without fault even when a part of measurement confirmation packet occurs because multiple measurement confirmation packets are sent to the receiving probe.

Each component of each device shown in the figures is functional concept and is not necessarily needed to be configured physically as shown in the figures. In other words, the concrete aspects of distribution or integration of each device are not limited to those shown in figures and a part or all of these can be configured functionally or physically distributed or integrated in arbitrary units. For example, the measurement packet sending unit 13c and the sent packet counter incrementing unit 13d may be integrated. Further, all or an arbitrary part of processing function performed in each device can be implemented by using CPU and analytical programs executed on the CPU, or by using wired-logic hardware.

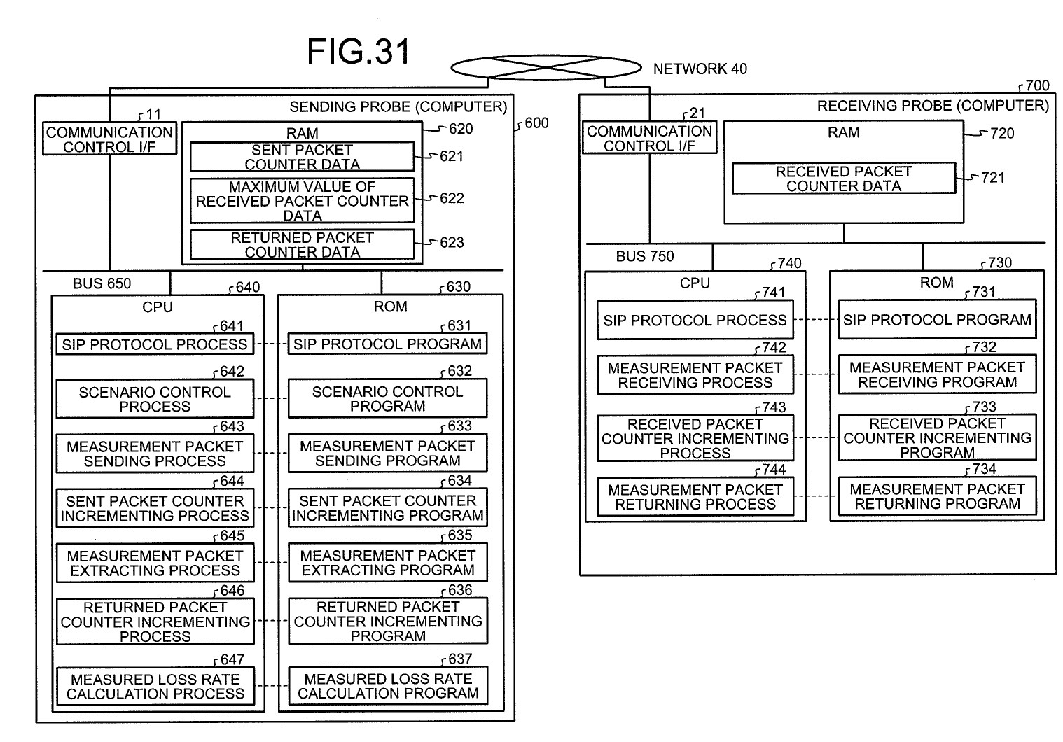

All sorts of processes described in the embodiments can be implemented by executing programs prepared for the purposes on a computer. Referring to FIG. 31, a computer that executes programs having the same function as the embodiments is described. FIG. 31 is a diagram of a computer that performs a packet loss rate calculation process.

As shown in FIG. 31, a computer 600 as a sending probe is configured with a RAM 620, a ROM 630, and a CPU 640, which are all connected by a Bus 650.

The ROM 630 stores a SIP protocol program 631, a scenario control program 632, a measurement packet sending program 633, a sent packet counter incrementing program 634, a measurement packet extracting program 635, a returned packet counter incrementing program 636, and a measured loss rate calculation program 637 as shown in FIG. 31 to implement a sending probe having the similar function as in the embodiments. The programs 631 to 637 can arbitrarily be distributed or integrated similar to each component of the sending probe 10 shown in FIG. 3.

The CPU 640 reads out the programs 631 to 637 from the ROM 630 and executes them, so that each of the programs 631 to 637 functions as an SIP protocol process 641, a scenario control process 642, a measurement packet sending process 643, a sent packet counter incrementing process 644, a measurement packet extracting process 645, a returned packet counter incrementing process 646, and a measured loss rate calculation process 647 respectively. Each of the processes 641 to 647 corresponds to the SIP protocol unit 13a, the scenario control unit 13b, the measurement packet sending unit 13c, the sent packet counter incrementing unit 13d, the measurement packet extracting unit 13e, the returned packet counter incrementing unit 13f, and the measured loss rate calculation unit 13g shown in FIG. 3 respectively.

The CPU 640 registers data to sent packet counter data 621, a maximum value of received packet counter data 622, returned packet counter data 623, and also executes packet loss rate calculation process by using the sent packet counter data 621, the maximum value of the received packet counter data 622, and the returned packet counter data 623.

As shown in FIG. 31, a computer 700 as a receiving probe is configured with a RAM 720, a ROM 730, and a CPU 740, which are all connected via a Bus 750.

The ROM 730 stores a SIP protocol program 731, a measurement packet receiving program 732, a received packet counter incrementing program 733, a measurement packet returning program 734 as shown in FIG. 31 to implement a receiving probe having similar function to the embodiments. The programs 731 to 734 can arbitrarily be distributed or integrated similar to each component of the receiving probe 20 shown in FIG. 11.

The CPU 740 reads out the programs 731 to 734 from the ROM 730 and executes them, so that each of the programs 731 to 734 functions as an SIP protocol process 741, a measurement packet receiving process 742, a received packet counter incrementing process 743, and a measurement packet returning process 744 as shown in FIG. 31. Each of the processes 741 to 744 corresponds to the SIP protocol unit 22a, the measurement packet receiving unit 22b, the received packet counter incrementing unit 22c, and the measurement packet returning unit 22d shown in FIG. 11 respectively.

The CPU 740 registers data to received packet counter data 721, and executes calculation of packet loss rate by using the received packet counter data 721.

As described above, according to one aspect of the present invention, packet loss rate with high accuracy can be calculated in forward as well as in the backward path.

Furthermore, according to another aspect of the present invention, even when the last quality measurement packet was lost, the packet loss rate at the end of the quality measurement can be calculated by resending the received packet count that is stored in the receiving probe at the end of the quality measurement.

Moreover, according to another aspect of the present invention, even when a part of measurement confirmation packet occurs, the packet loss rate at the end of quality measurement can be calculated without fault.

Furthermore, according to another aspect of the present invention, even when a quality measurement packet was lost during measurement of packet loss, the packet loss rate at that time point can be calculated.

Moreover, according to another aspect of the present invention, even when a part of measurement confirmation packet occurs, the packet loss rate during measurement of loss rate can be calculated without fault.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A packet loss rate calculation system that exchanges a quality measurement packet for measuring quality of service between a sending probe and a receiving probe and calculates a packet loss rate between measuring points based on information obtained from the quality measurement packet, wherein
the sending probe includes
a sent packet count memory unit that stores a sent packet count of quality measurement packets sent to the receiving probe,
a returned packet count memory unit that stores a returned packet count of quality measurement packets returned from the receiving probe,
a measurement packet sending unit that sends the quality measurement packet to the receiving probe,
a packet count incrementing unit that increments the sent packet count stored in the sent packet count memory unit every time the measurement packet sending unit sends the quality measurement packet,
a measurement packet extracting unit that receives the returned quality measurement packet, and extracts a received packet count indicating a packet count received by the receiving probe from the quality measurement packets,
a returned packet count incrementing unit that increments the returned packet count stored in the returned packet count memory unit every time the returned quality measurement packet is received, and
a loss rate calculation unit that calculates the packet loss rate by using a difference between the sent packet count stored in the sent packet count memory unit and the received packet count extracted by the measurement packet extracting unit and a difference between the received packet count extracted by the measurement packet extracting unit and the returned packet count stored in the returned packet count memory unit, and
the receiving probe includes
a received packet count memory unit that stores a received packet count of quality measurement packets received from the sending probe,
a measurement packet receiving unit that receives the quality measurement packet sent by the measurement packet sending unit,
a received packet count incrementing unit that increments the received packet count stored in the received packet count memory unit every time the measurement packet receiving unit receives the quality measurement packet, and
a measurement packet returning unit that attaches the received packet count stored in the received packet count memory unit to the quality measurement packet, and returns the quality measurement packet with the received packet count attached to the sending probe every time the measurement packet receiving unit receives the quality measurement packet.

2. The packet loss rate calculation system according to claim 1, wherein
the sending probe further includes
a confirmation packet sending unit that sends a measurement confirmation packet to the receiving probe to confirm measurement result of the receiving probe after all quality measurement packets have been sent to the receiving probe,
a confirmation packet extracting unit that receives the measurement confirmation packet returned from the receiving probe, and extracts the received packet count from the measurement confirmation packet, and
a confirmed loss rate calculation unit that calculates the packet loss rate by using the difference between the sent packet count stored in the sent packet count memory unit and the received packet count extracted by the confirmation packet extracting unit, and the difference between the received packet count extracted by the confirmation packet extracting unit and the returned packet count stored in the returned packet count memory unit, and
the receiving probe further includes
a confirmation packet receiving unit that receives the measurement confirmation packet sent by the confirmation packet sending unit, and
a confirmation packet returning unit that attaches the received packet count stored in the received packet count memory unit to the measurement confirmation packet and returns it to the sending probe when the confirmation packet receiving unit receives the measurement confirmation packet.

3. The packet loss calculation system according to claim 2, wherein the confirmation packet sending unit sends a plurality of measurement confirmation packets to the receiving probe.

4. The packet loss calculation system according to claim 1 wherein
the sending probe further includes
a packet under measurement sending unit that attaches the sent packet count stored in the sent packet count memory unit to a measurement confirmation packet for confirming a measurement result of the receiving probe at an arbitrary timing during sending of the quality measurement packet, and sends the measurement confirmation packet to the receiving probe,
a received packet under measurement extracting unit that receives the measurement confirmation packet returned from the receiving probe, and extracts the sent packet count and received packet count from the measurement confirmation packet, and
a loss rate under measurement calculation unit that calculates the packet loss rate by using a difference between the sent packet count extracted by the packet under measurement extracting unit and the received packet count extracted by the received packet under measurement extracting unit and a difference between the received packet count extracted by the received packet under measurement extracting unit and returned packet count stored in the returned packet count memory unit, and
the receiving probe further includes
a sent packet under measurement receiving unit that receives the measurement confirmation packet from the packet under measurement sending unit, and
a packet under measurement returning unit that attaches the received packet count stored in the received packet count memory unit to the measurement confirmation packet, and returns the measurement confirmation packet with the received packet count attached to the sending probe, upon the sent packet under measurement receiving unit receiving the quality measurement packet.

5. The packet loss calculation system according to claim 4, wherein packet under measurement sending unit sends a plurality of measurement confirmation packets to the receiving probe.

6. A computer-readable recording medium that stores therein a computer program for exchanging a quality measurement packet for measuring quality of service between a sending probe and a receiving probe and calculating a packet loss rate between measuring points based on information obtained from the quality measurement packet, wherein
the computer program causes a computer to execute as the sending probe
sent packet count storing including storing a sent packet count of quality measurement packets sent to the receiving probe,
returned packet count storing including storing a returned packet count of quality measurement packets returned from the receiving probe,
measurement packet sending including sending the quality measurement packet to the receiving probe,
packet count incrementing including incrementing the sent packet count stored at the sent packet count storing every time the quality measurement packet is sent,
measurement packet extracting including
receiving the returned quality measurement packet, and
extracting a received packet count indicating a packet count received by the receiving probe from the quality measurement packets,
returned packet count incrementing including incrementing the returned packet count stored at the returned packet count storing every time the returned quality measurement packet is received, and
loss rate calculating including calculating the packet loss rate by using a difference between the sent packet count stored at the sent packet count storing and the received packet count extracted at the measurement packet extracting and a difference between the received packet count extracted at the measurement packet extracting and the returned packet count stored at the returned packet count storing, and
the computer program causes a computer to execute as the receiving probe
received packet count storing including storing a received packet count of quality measurement packets received from the sending probe,
measurement packet receiving including receiving the quality measurement packet sent at the measurement packet sending,
received packet count incrementing including incrementing the received packet count stored at the received packet count storing every time the quality measurement packet is received, and
measurement packet returning including
attaching the received packet count stored at the received packet count storing to the quality measurement packet, and
returning the quality measurement packet with the received packet count attached to the sending probe every time the quality measurement packet is received.
